(19) United States
(12) Patent Application Publication
(10) Pub. No.: US 2025/0355688 A1
(43) Pub. Date: Nov. 20, 2025

(54) Interactive AI-Driven Soft Skills Training System with Real-Time Feedback and Adaptive Scenario Generation

(71) Applicant: CGS Global Immersive Inc., New York, NY (US)

(72) Inventors: Philip Friedman, New York, NY (US); Douglas Stephen, Saint John, New Brunswick (CA); Micah White, Rothesay (CA)

(21) Appl. No.: 19/213,989

(22) Filed: May 20, 2025

Related U.S. Application Data
(60) Provisional application No. 63/649,675, filed on May 20, 2024.

(51) Int. Cl. G06F 9/451; G06T 13/40; G06V 40/20; H04L 51/02

(52) U.S. Cl. CPC G06F 9/453; G06T 13/40; G06V 40/20; H04L 51/02

(57) ABSTRACT

The present disclosure is a system and method to provide an interactive AI-driven soft skills training system that simulates realistic scenarios based on a five-factor personality model. It offers personalized coaching, real-time feedback, and a rewind and retry feature for iterative learning. Additionally, the system includes a meta-prompt functionality to generate industry-specific simulations by leveraging large language models to search and integrate relevant data, providing a comprehensive and adaptive training environment.

### CROSS-REFERENCE TO RELATED APPLICATIONS

This application claims the benefit and priority to U.S. Provisional Patent Application Ser. No. 63/649,675 filed May 20, 2024, which is incorporated by reference herein.

### BACKGROUND

Soft skills in a business environment are important assets for employees to develop, improve, and master. Ninety-three percent of hiring managers consider soft skills to be essential when hiring or recruiting new employees. This is because soft skill abilities impact overall business performance, customer satisfaction and experience, and workplace relationships. However, soft skills are difficult to develop, often requiring one-to-one coaching from more experienced individuals, or years of experience. Moreover, many soft skills are industry- or situation-specific. This make it difficult to prepare for or teach soft skill development for many situation-specific instances.

For example, in many industries, an employee's ability to use soft skills, such as de-escalation tactics when encountering unruly or disruptive customers can only be practiced in the real world, during actual confrontations. This makes generic soft skill training inapplicable in most high-need circumstances. Traditional soft skills training programs, classes, or curricula tend to be generic or only offer a one-size-fits-all approach to soft skill development. Traditional training programs also tend to focus on theoretical issues, rather than real-world experiences. Because of the nature of soft skills themselves, it can be difficult to track, measure, and assess an individual's soft skill abilities, improvements, or growth. This limits user-specific feedback, engagement, and scalability of current soft skills development programs. The upshot is that there is an estimated $160 billion annual economic loss due to the so-called soft skills gap.

Therefore, there exists a long-felt, but unmet, need for a contextualized, immersive, readily accessible, affordable, data-driven, customizable, and personalized way to train and track soft skill development for improved workplace performance.

### SUMMARY OF THE DISCLOSURE

The present disclosure relates to systems and methods for training individuals in soft skills, such as communication, negotiation, and conflict resolution, through interactive AI-driven simulations. Existing methods of soft skills training are often limited by their generic approach, lack of real-time feedback, and inability to tailor training to specific industry needs. The present disclosure provides an interactive soft skills training system utilizing advanced AI technologies to create realistic, adaptive simulations. The system includes features for personalized coaching, real-time feedback, and the ability to generate industry-specific scenarios through user-defined meta-prompts.

These and other aspects of the disclosure will be further explained below.

### BRIEF DESCRIPTION OF THE DRAWINGS

The Detailed Description is described with reference to the accompanying figures. The use of the same reference numbers in different instances in the description and the figures may indicate similar or identical items.

FIG. 1 depicts an embodiment of the system architecture to support the present disclosure.

FIG. 2 depicts a flowchart of the disclosed AI algorithm's process for simulating interactions and providing real-time feedback.

FIG. 3 depicts additional features of the disclosed system and method to improve soft skill development.

FIG. 4 presents an example of the meta-prompt creation process and the generation of industry-specific scenarios.

FIG. 5 depicts a view of the user-interface in a scenario simulation.

FIG. 6 depicts another view of the user-interface in a scenario simulation.

FIG. 7 depicts another view of the user-interface in a scenario simulation.

FIG. 8 depicts another view of the user-interface in a scenario simulation.

FIG. 9 depicts another view of the user-interface in a scenario simulation.

FIG. 10 depicts the user interface used to begin the scenario creation process.

FIG. 11 depicts the user interface used to select main and fallback LLMs.

FIG. 12 depicts the user interface associated with beginning voice-driven scenario building.

FIG. 13 depicts the user interface associated with voice-driven scenario building.

FIG. 14 depicts another view the user interface associated with voice-driven scenario building.

FIG. 16 depicts another view the user interface associated with voice-driven scenario building.

FIG. 17 depicts the user interface for adding conversational milestones to a scenario.

FIG. 18 depicts a view of the user interface by which a user can generate an AI avatar.

FIG. 19 depicts another view of the user interface by which a user can generate an AI avatar.

FIG. 20 depicts another view of the user interface by which a user can generate an AI avatar.

FIG. 21 depicts another view of the user interface by which a user can generate an AI avatar.

FIG. 22 depicts another view of the user interface by which a user can generate an AI avatar.

FIG. 23 depicts another view of the user interface by which a user can generate an AI avatar.

FIG. 24 depicts another view of the user interface by which a user can generate an AI avatar.

FIG. 25 depicts another view of the user interface by which a user can generate an AI avatar.

FIG. 26 depicts another view of the user interface by which a user can generate an AI avatar.

FIG. 27 depicts another view of the user interface by which a user can generate an AI avatar.

FIG. 28 depicts another view of the user interface by which a user can generate an AI avatar.

FIG. 29 depicts the user interface for a WebRTC chatroom in accordance with the present disclosure.

FIG. 30 depicts a portion of the user interface for an AI Dialing and Conversation Engine in accordance with the present disclosure.

FIG. 31 depicts another portion of the user interface for an AI Dialing and Conversation Engine in accordance with the present disclosure.

FIG. 32 depicts the user interface for a Multi-Dimension Skill Tracker in accordance with the present disclosure.

FIG. 33 shows the logical architecture of a system in accordance with the present disclosure.

FIG. 34 shows a deployment diagram of a system in accordance with the present disclosure.

FIG. 35 depicts a portion of the user interface used for manipulating the personality traits of a chatbot in scenario building.

FIG. 36 depicts a portion of the user interface used for manipulating the personality traits of a chatbot in scenario building using psychometric sliders.

FIG. 37 depicts a the user interface for selecting a premade AI avatar.

FIG. 38 depicts a portion of the user interface for fast mode scenario building.

FIG. 39 depicts another portion of the user interface for fast mode scenario building.

FIG. 40 depicts another portion of the user interface for fast mode scenario building.

FIG. 41 depicts publication options for a user-built scenario.

FIG. 42 depicts a portion of the feedback provided to a user following scenario completion.

FIG. 43 depicts another portion of the feedback provided to a user following scenario completion.

FIG. 44 depicts another portion of the feedback provided to a user following scenario completion.

FIG. 45 shows a block diagram for generating a video-podcast based on documentation uploaded to a system in accordance with the present disclosure.

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete and will fully convey the scope of the invention to those skilled in the art. Among other things, the present invention may be embodied as methods or devices. The following detailed description is, therefore, not to be taken in a limiting sense.

In the following detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, certain well-known features may not be described in detail to avoid unnecessarily complicating the instant disclosure.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherently present therein.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

The term “and combinations thereof” as used herein refers to all permutations or combinations of the listed items preceding the term. For example, “A, B, C, and combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. A person of ordinary skill in the art will understand that typically there is no limit on the number of items or terms in any combination, unless otherwise apparent from the context.

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

The use of the terms “at least one” and “one or more” will be understood to include one as well as any quantity more than one, including, but not limited to, each of, 2, 3, 4, 5, 10, 15, 20, 30, 40, 50, 100, and all integers and fractions, if applicable, therebetween. The terms “at least one” and “one or more” may extend up to 100 or 1000 or more, depending on the term to which it is attached; in addition, the quantities of 100/1000 are not to be considered limiting, as higher limits may also produce satisfactory results.

Further, as used herein any reference to “one embodiment” or “an embodiment” means that a particular element, feature, structure, or characteristic described in connection with the embodiment is included in at least one embodiment. The appearance of the phrase “in one embodiment” in various places in the specification are not necessarily all referring to the same embodiment.

As used herein, qualifiers such as “about,” “approximately,” and “substantially” are intended to signify that the item being qualified is not limited to the exact value specified, but includes some slight variations or deviations therefrom, caused by measuring error, manufacturing tolerances, stress exerted on various parts, wear and tear, and combinations thereof, for example.

As used herein, “components” may be analog or digital components that perform one or more functions. The term “component” may include hardware, such as a processor (e.g., microprocessor), a combination of hardware and software, and/or the like. Software may include one or more computer executable instructions that when executed by one or more components cause the component to perform a specified function. It should be understood that any and all algorithms described herein may be stored on one or more non-transitory memory. Exemplary non-transitory memory may include random access memory, read only memory, flash memory, and/or the like. Such non-transitory memory may be electrically based, optically based, and/or the like.

The term “machine learning” generally refers to computer algorithms that may learn from pre-existing data and then make predictions about new data. Thus, machine-learning tools operate by building a model from example training data, which, for example, can be used to model an environment based on that training data and then make decisions or predictions without explicit instructions. Different machine-learning tools may be used. Deep learning or deep structured learning is a type of machine learning that can use artificial neural networks (e.g., inspired by biological systems) with representation learning. Representation learning is a set of techniques that allows a system to automatically discover representations needed to detect features in future sets of data. The learning of features is generally thought to be either supervised or unsupervised, although a hybrid of these approaches is also possible.

In “supervised learning,” a “teacher” presents the computer with the desired outputs given a set of example inputs. This is generally thought to involve classification and regression, which can be accomplished using one or more approaches including, but not limited to, decision trees, ensembles (e.g. Random Forest), nearest neighbors algorithm, linear regression, gBLUP (genomic best linear unbiased prediction), lasso (least absolute shrinkage and selection operator), lasso LARS, Ridge regression, Elastic Net, Naive Bayes, Artificial neural networks (ANN or NN), logistic regression, perceptron, Relevance vector machine (RVM), and Support vector machine (SVM). Generally, the approach to supervised learning used depends on the data set; among other issues involved in this choice is the amount of training data available, the dimensionality and heterogeneity of that data, redundancy in that data, the interrelations between data elements, and the amount of noise present in the output.

In “unsupervised learning,” the computer is left to find any naturally occurring patterns within the training data. This can be accomplished by using one or more approaches including, but not limited to, clustering (i.e., automatically grouping the training examples into categories with similar features), anomaly detection, principal component analysis (i.e., automatically identifying features that are most useful for discriminating between different training examples and then discarding the rest), self-organizing feature maps, and latent variable models. Clustering methods include hierarchical clustering, k-means, mixture models (i.e., a probabilistic model that represents the presence of subpopulations within an overall population), DBSCAN (density-based spatial clustering of applications with noise), expectation-maximization, BIRCH, and CURE.

One or more of the foregoing supervised and unsupervised machine learning approaches may be used by the present system and methods in parallel or seriatim using the same training data or subsets thereof. Where subsets are used, the scope of any such subset may be selected for use with the particularly selected training data within that subset with reference to the pluses and minuses of one or more of the particular approaches to machine learning. Where multiple machine learning approaches are used in parallel (i.e., stacked), a decision-making model is preferably introduced to mediate between the probability assessments provided by the multiple machine learning models toward providing a single list of recommended actions (e.g., providing user-specific soft skill feedback and development).

### System Architecture, Generally

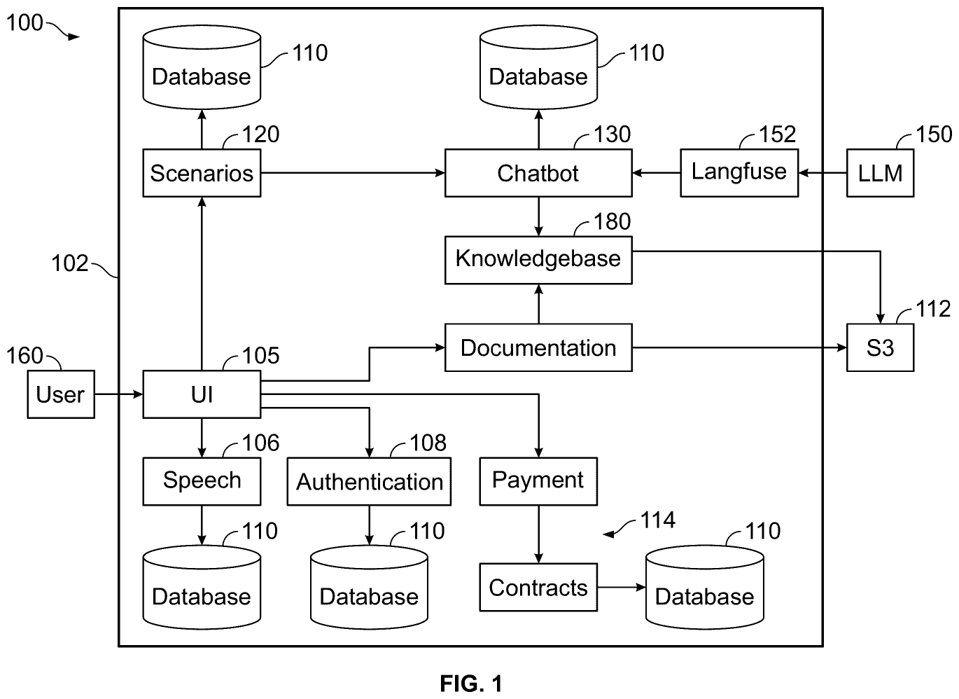

As depicted by FIG. 1, the disclosed system and method 100 comprises a server 102, a database 110, user interfaces 105, and machine learning (ML)/artificial intelligence (AI) components 150, 130. Generally speaking, the server 102 handles requests from a user 160 and processes relevant data, while the database 110 stores user profiles, training scenarios 120, and feedback logs. The user interfaces 105 allow users to interact with the system via web, VR, and mobile platforms.

The server 102 may be any server, as known in the art, that is capable of communicating with a user 160 via the disclosed user interfaces 105. A user 160 may interact with the disclosed system and method 100 via any device known in the art, including a personal device, such as a cellphone or personal computer or laptop, via a mobile application, a website, a virtual reality or augmented realty device, or any other personal device known in the art. The user 160 may create a profile to store the user's 160 information and progress when interacting with the disclosed system and method 100. The present disclosure 100 may further comprise a speech component 106 which may interact with a user 160 through the disclosed interface 105. The speech component 106 may record the user's 160 responses to certain prompts in particular scenarios 120. The speech component 106 allows a user 160 to speak naturally as they interact with the chatbot 130 or other learning features disclosed herein. This allows a user 160 to learn dynamically in a manner not previously possible. By allowing a user 160 to speak naturally in novel training scenarios 120, the user's soft skill development benefits because this mode of learning reflects how a user 160 would have to respond to a similar situation in the workplace. The results of a user's 160 experiences and progress interacting with the user interface 105 as it relates to particular scenarios 120 is stored in a database 110 to track a user's progress and growth.

The database 110 stores multiple data sources including information related to industry-or user-specific scenarios 120, chatbot 130 data, contract and payment 114 data, data related to speech 106, authentication 108, and any other data sources as would be known in the art. A cloud based storage unit 112 is also disclosed.

The disclosed server 102 may also store information relevant to payment, contracts with users, and/or subscription information. As discussed in detail below, the user 160 via a user interface 105 improves their soft skill development via various industry-specific scenarios 120, supported by a chatbot 130. The disclosed chatbot 130 is trained using the machine learning system 150 and is used to strengthen a user's 160 soft skill training. The chatbot 130 is supported by the machine learning program 150, which is iteratively and regularly trained on new data inputs to continuously improve the user experience. The machine learning program 150 is supported by a support network 152, which is preferably an open source support network 152 which can aid in addressing any issues or bugs in the machine learning 150 algorithms.

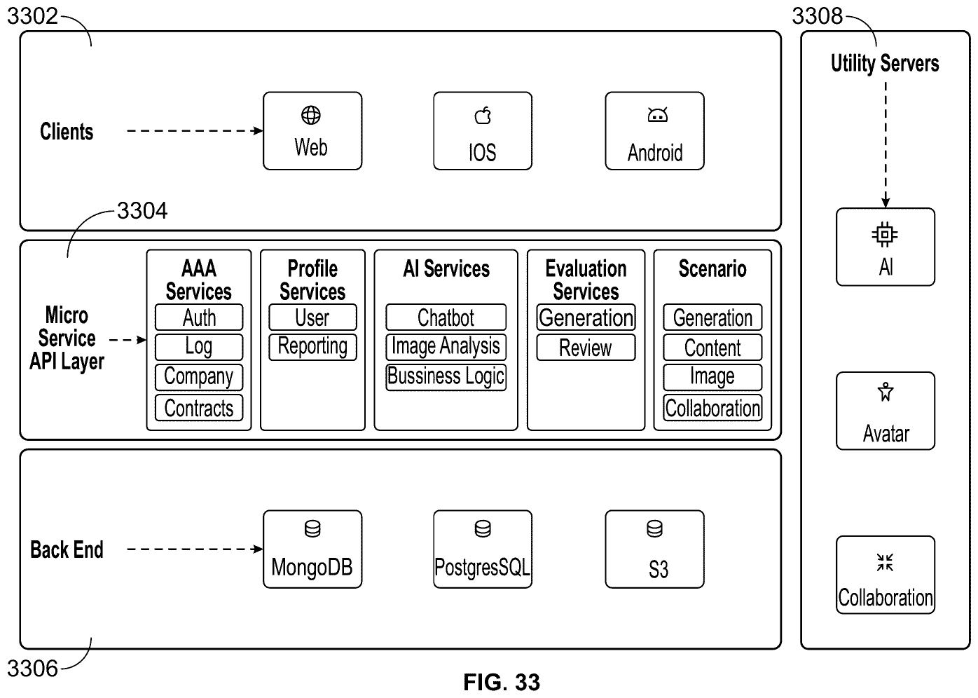

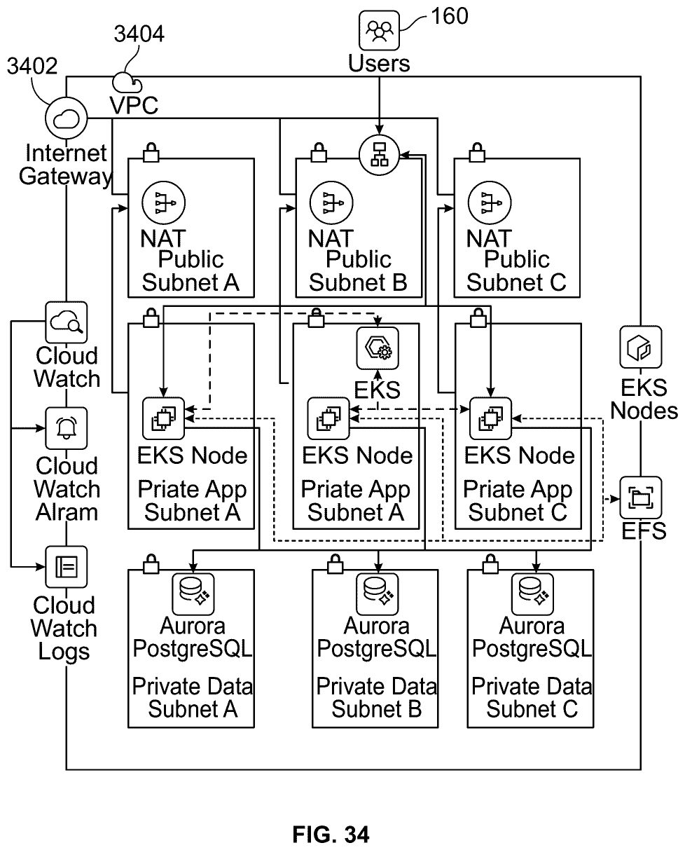

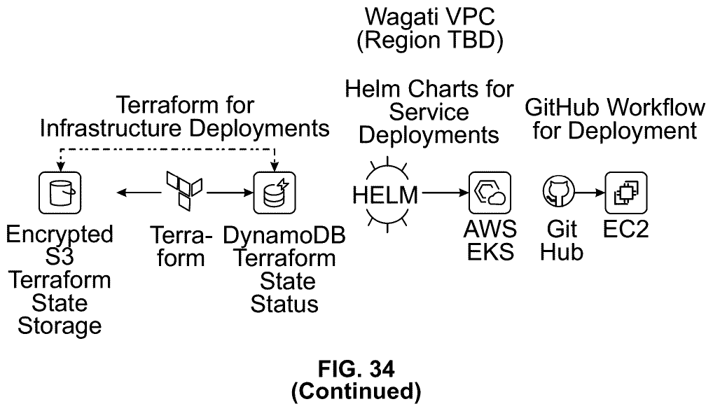

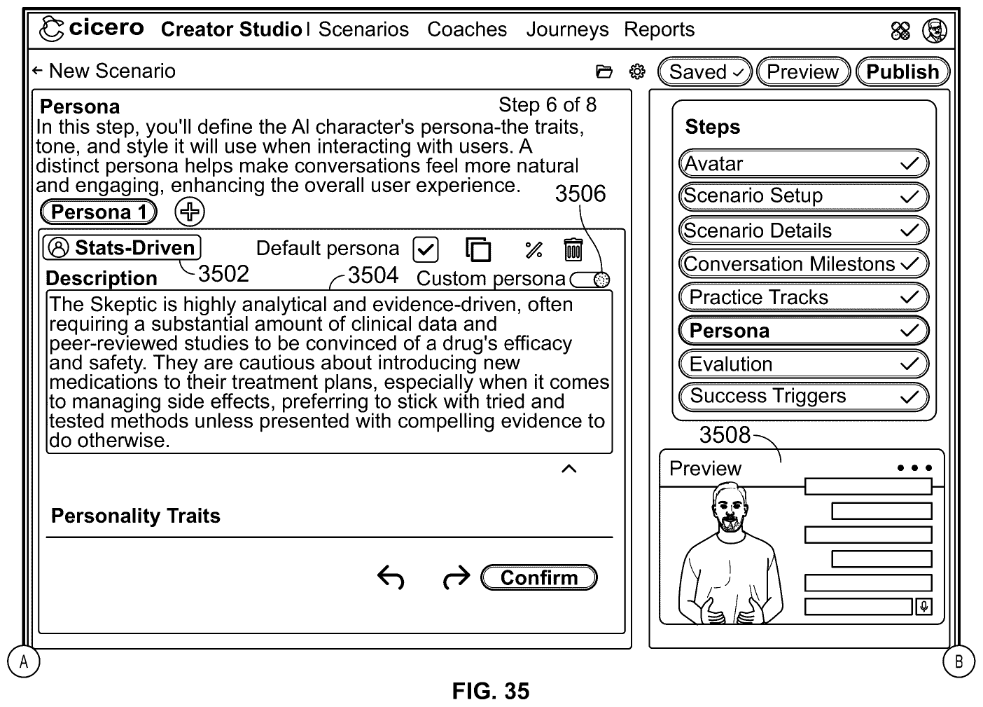

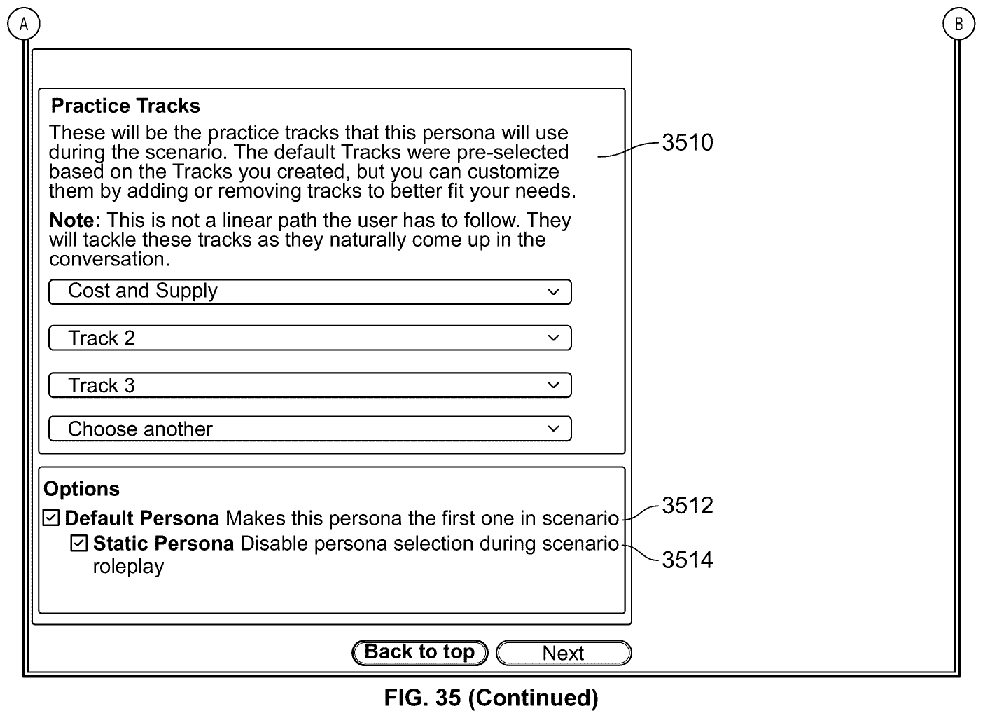

In embodiments, and as shown by FIG. 33, the disclosed system and method comprise a client layer 3302 whereby a user 160 may interact with the system 100 via the web and iOS or Android platforms. The client layer 3302 is operatively connected to the micro service API layer 3304 which facilitates various functionality such as user 160 authentication, chatbot 130 services, and scenario 120 generation. The micro service API layer 3304 is, in turn, operatively connected to the system's 100 backend layer 3306 which comprises one or more databases such as MongoDB, PostgressSQL, and cloud-based data bases for storing information. Utility servers 3308 aid with functionality across the client layer 3302, micro service API layer 3304, and backend layer 3306. As shown by FIG. 34, a plurality of users 160 may interact with the back end layer 3306 servers by sending requests through an internet gateway 3402.

### Machine Learning/Artificial Intelligence Trained to Support the Development of Soft Skills

The disclosed system and method 100 employs ML/AI algorithms to simulate interactions based on psychometric sliders. These algorithms dynamically adjust scenarios in real-time, providing users 160 with personalized and evolving training experiences. The machine learning model 150 integrates natural language processing (NLP) and machine learning (ML) techniques to analyze user responses and generate realistic dialogue. The inputs used to train the machine learning program 150 originate from industry experts or other sources that will allow the system to be trained with relevant and current best practices to offer users 160 an experience that will match situations they will encounter in the workplace environment.

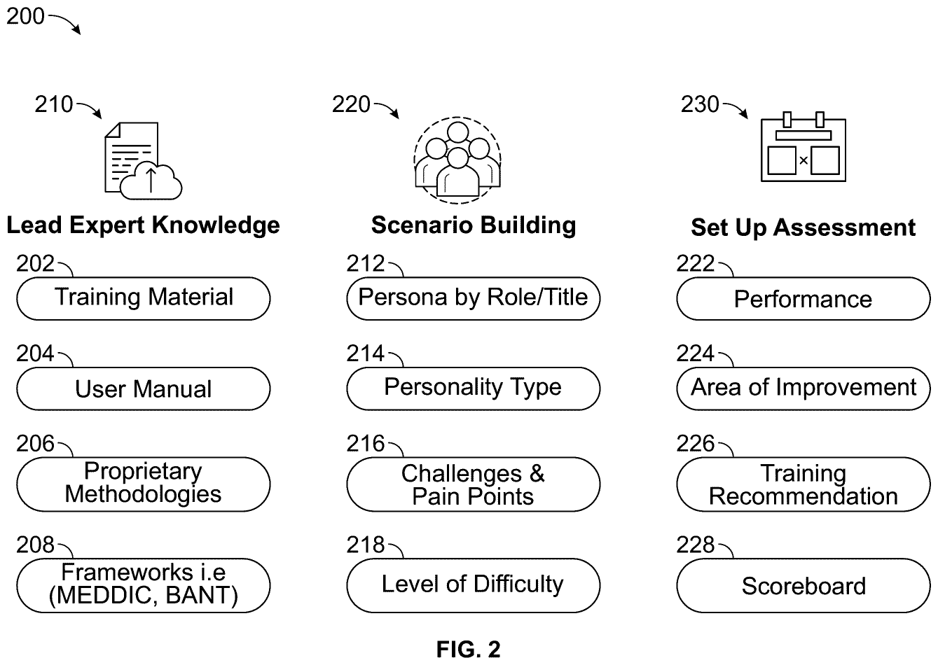

As depicted by FIG. 2, the machine learning model 150 is supported by expert knowledge 210. This knowledge base is used to train the machine learning model 150, and stored in the knowledge base 180 depicted in FIG. 1. This knowledge base 180 is communicated to a user 160 through the chatbot 130. The machine learning model 150 may be trained with specific expert knowledge loaded onto the disclosed system 210, as well as training manuals 202, user manuals 204, training methodologies 206, and other industry-specific training programs 208. These materials may be generalized or industry-specific and will include any information useful to train users 160 through simulated scenarios 120. These materials will also be supported by the chatbot 130, which is continuously improved by the disclosed machine learning model 150 to create better industry-specific scenarios designed to help a user 160 strengthen and improve their workplace soft skills.

### User Experience

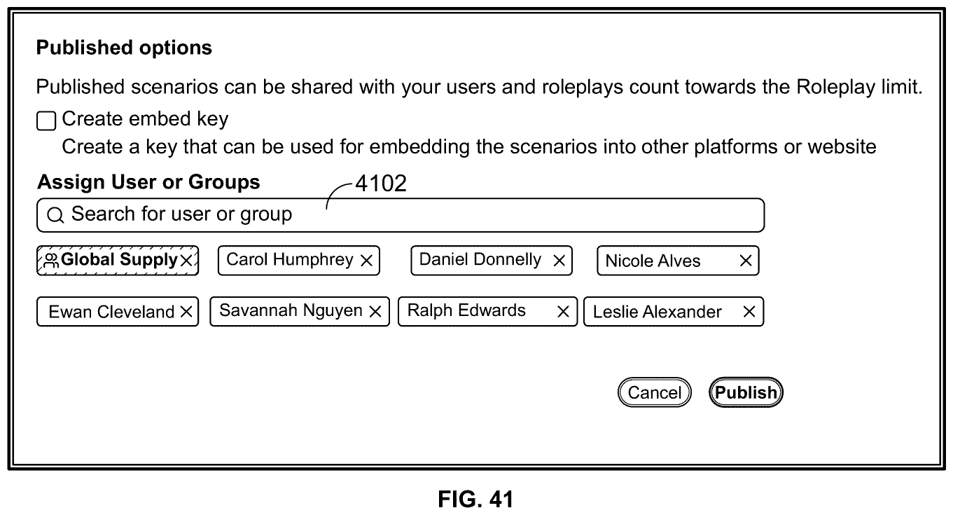

To improve their soft skills, a user 160 can access the disclosed system and method 100 via user interface 105 to interface with industry-specific scenarios 120 designed to improve soft skills. These scenarios 160 can be designed 220 to meet a user's 160 needs. Scenario building 220 entails generating a persona with a specific role and title 212, determining the personality type 214 (as discussed more below), identifying challenges 216 needed for growth, and setting the level of difficulty 218. Once the preferred scenario is created 220, a user 160 will take an assessment 230, which will identify the user's performance 222, areas for potential improvement 224, recommendations for additional training 226, and tally the user's score via a scoreboard 228. The user experience is supported by psychometric sliders which allow for an enhanced and more realistic training experience. Once created, user 160 generated scenarios 120 can be published for access by assigned users or groups 4102 as shown in FIG. 41.

Feedback mechanisms from the disclosed system 100 include textual comments, voice guidance, visual indicators, as well as any other teaching tools that will be understood in the art to help users 160 understand and improve their soft skills.

To access the disclosed system and methods, a user 160 may connect to the user interface 105, register, enter payment and contracts service information, pays for services, enter a contract, and authenticate their account to access soft skills development tools.

A scenario 120 may be created and accessed by a user by clicking on a scenario 120, accessing the scenario services, opting for a fast track 1004, detailed 1006 or voice-guided 1008 scenario service, and entering information to the user interface 105 about the scenario 120. The system 100 also allows users 160 to track the number of scenarios they have created and engaged with 1010, 1012. The scenario service will communicate via the chatbot 130 to generate prompts, which will be corrected if needed by the disclosed machine learning system 150, and repeated to create the scenario 120. When a user 160 is satisfied with the scenario 120, the scenario 120 can be saved in a database 110.

A user may access a scenario 120 in connection with scenario 120 creation or review, or a user 160 may consume the scenario as a production use of the scenario 120. The user 160 will connect to the system and, if an account does not already exist then, they will be asked to register an existing organization. The user will choose the scenario and the data will be retrieved from the scenario service. The disclosed system 100 will communicate via a chatbot 130 to determine the user, the roleplay they are doing and the other parameters of the roleplay. Then the chatbot 130 will generate the necessary information by using the machine learning model 150, and the user interface 105 will initiate roleplay with the user 160.

### Rewind and Retry Functionality

In an embodiment, the disclosed system 100 deterministically snapshots conversation states with the chatbot 130 (including aspects such valence, activation, impatience, dominance, and trust), enabling branch-and-replay while preserving a complete attempt history. Users 160 can rewind the chatbot 130 conversation to a previous point and attempt different tactics.

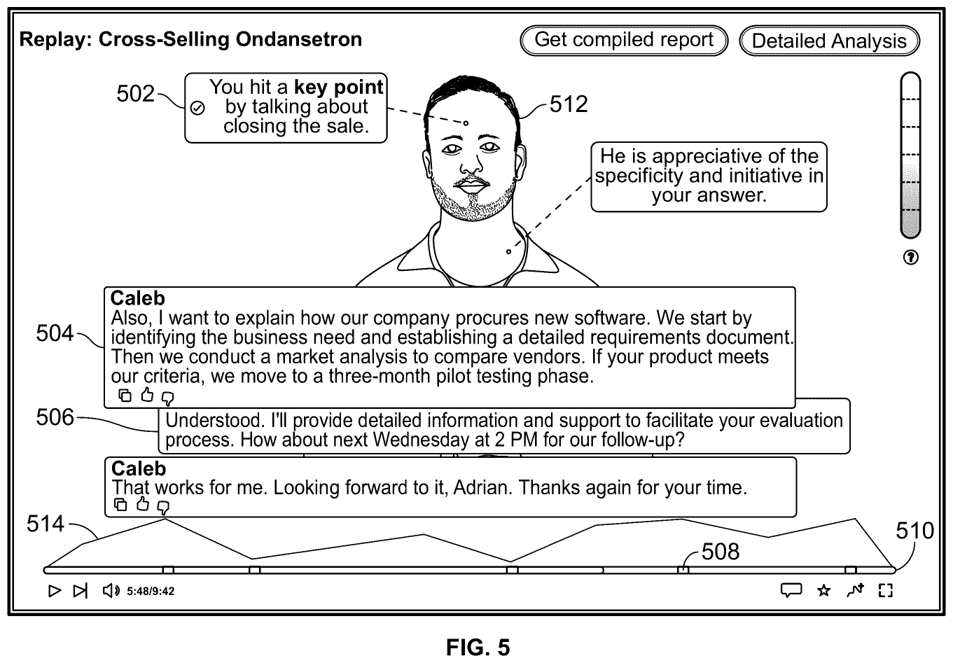

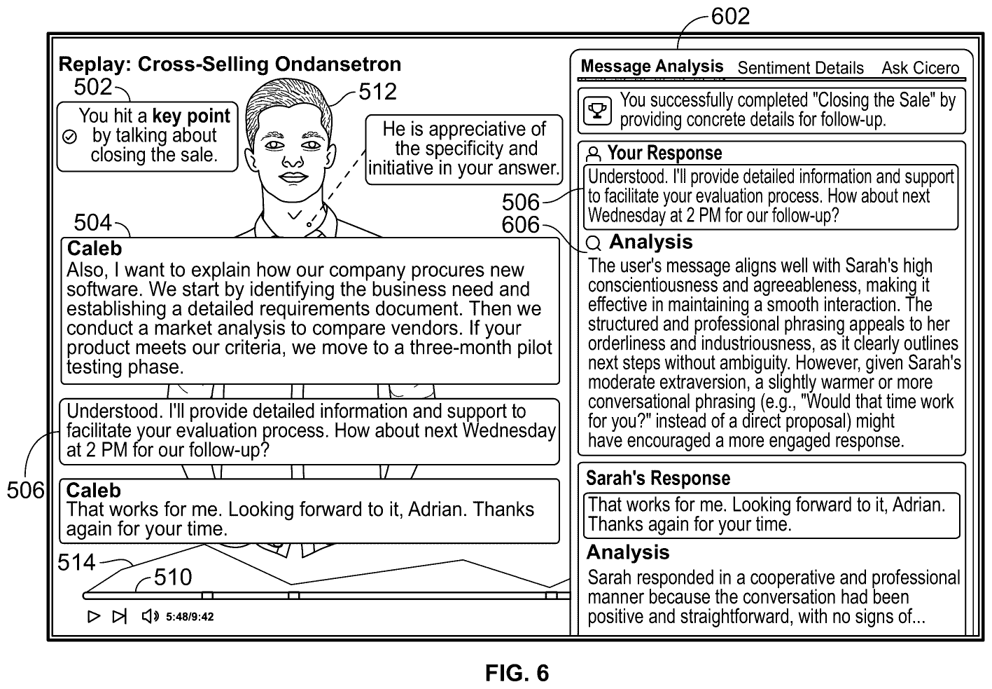

By way of example, and in accordance with FIG. 5, the user 160 may select a message 504, 506 or a benchmark 508 from their conversation with the chatbot 130 to retry the conversation from that point. The user's 160 conversation with the chatbot 130 branch from that point, and the user 160 can then review and receive feedback with respect to each conversational branch.

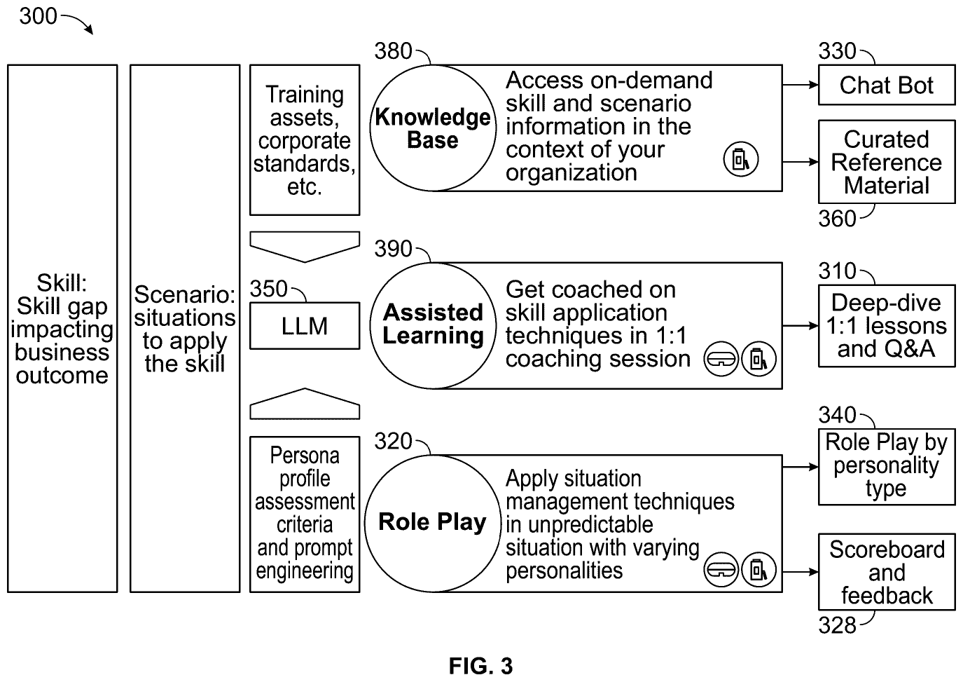

This feature allows for iterative learning and skillset development and helps users 160 explore various strategies in handling challenging interactions or scenarios 120. FIG. 3 shows several of the additional forms of feedback a user may receive, such as, without limitation, one-on-one practice 310, on-demand coaching 390, role playing 340, and additional reference materials 360. This progress and feedback is tracked on a scoreboard 328 to allow a user 160 to monitor and track their progress and to continuously aid a user 160 to identify areas for improvement.

### Behavioral Analysis Engine and Complex Emotion Telemetry

In a further embodiment, the disclosed system 100 includes a behavioral analysis engine and complex emotion telemetry. These features read faces, voices, and text through facial vectors, speech prosody, and textual context.

Based on these readings, the behavioral analysis engine is able to perform a real-time extraction and normalization of various aspects of the user's 160 conversation with the chatbot 130. Such aspects include the conversation's valence (positive or negative), activation (high intensity or low intensity), and secondary traits such as rapport and trust, dominance, and impatience.

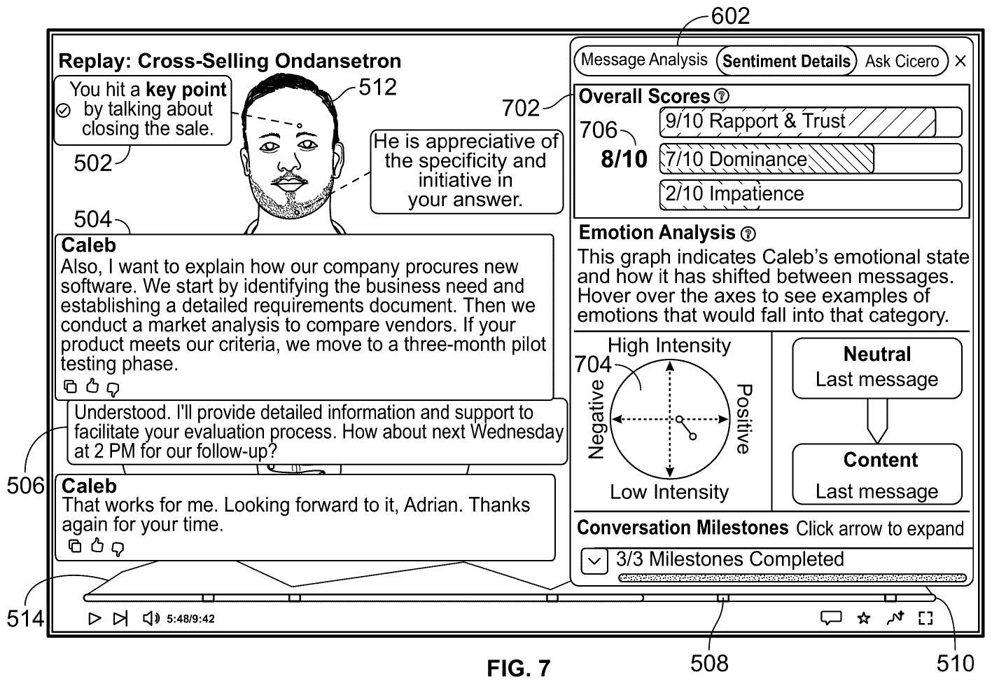

As depicted in FIG. 7, the behavioral analysis engine assigns a numerical score to each of these conversational aspects in a unified space optimized for coaching. The valence and activation 704 of the user's 160 conversation with the chatbot 130 are scored on a scale including both negative and positive numbers (e.g., −3 . . . +3). The secondary traits 702 are scored out of a total number (e.g., out of 10). Based on these component scorings, the behavioral analysis engine compiles an overall score 706 for the user 160.

The behavioral analysis engine also provides message analysis 602, which provides written feedback to each of the messages generated by the user 160 in response to the chatbot 130 throughout the course of a scenario 120. This feedback highlights the strengths and weaknesses of the user's 160 messages in the context of the scenario 120. For instance, feedback may be provided based on the appeal of the user's 160 message to the specific personality traits of the chatbot 130 (as are determined by the user 160 in scenario 120 building).

### Augmented Feedback Overlay

In another embodiment, the user interface 105 of the disclosed system 100 incorporates an augmented feedback overlay. As depicted in FIG. 5, the augmented feedback overlay includes pop-ups 502 over the user interface 105 of the scenario 120. These pop-ups 502 appear in synchronization with playback and include helpful tips, links and badges.

These pop-ups 502 enable users 160 to evaluate their performance in real time. For instance, a pop-up 502 may inform the user 160 that they just hit a key point of the conversation or that the chatbot 130 is appreciative of the user's 160 detailed answer to the chatbot's 130 question. Such feedback reinforces positive user behavior and speech, thereby improving their soft skills.

### Timeline Analysis Interface

In one embodiment, the user interface 105 of the disclosed system 100 includes a timeline analysis interface for multi-track telemetry. More specifically, the timeline analysis interface comprises an interactive ribbon 514 which layers conversation turns, emotion curves, and milestone flags 508 with click-to-zoom navigation.

The timeline analysis interface provides users 160 with a concrete user interface solution for visualizing progress and emotional data. Indeed, by providing users 160 with precise points in their conversation with the chatbot 130 which yielded positive or negative reactions, user's 160 can quickly and easily navigate to points of their conversation to see what worked and what didn't in the context of a given scenario 120.

### Instant Coaching Module

The disclosed system and method 100 offers a coaching module where users 160 can focus on specific aspects of soft skills, such as overcoming objections in sales, disruptive customers, or any other situation that may require soft skill development. The coaching module provides real-time feedback and suggestions based on the user's 160 performance 222. As depicted in FIGS. 2 and 3, a user can receive on-demand soft skills support 380 and assessment 230, coaching 390, guidance materials 360, chatbot-assisted feedback 330, one-on-one lessons 310, role playing 340 support, and scenario-specific practice 320 to improve their skills.

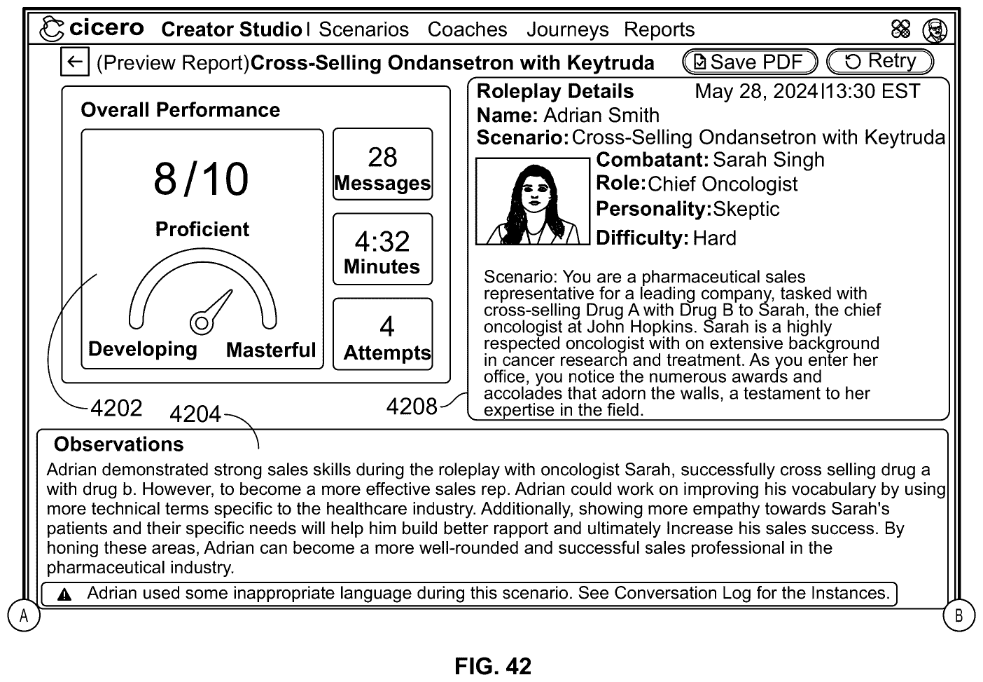

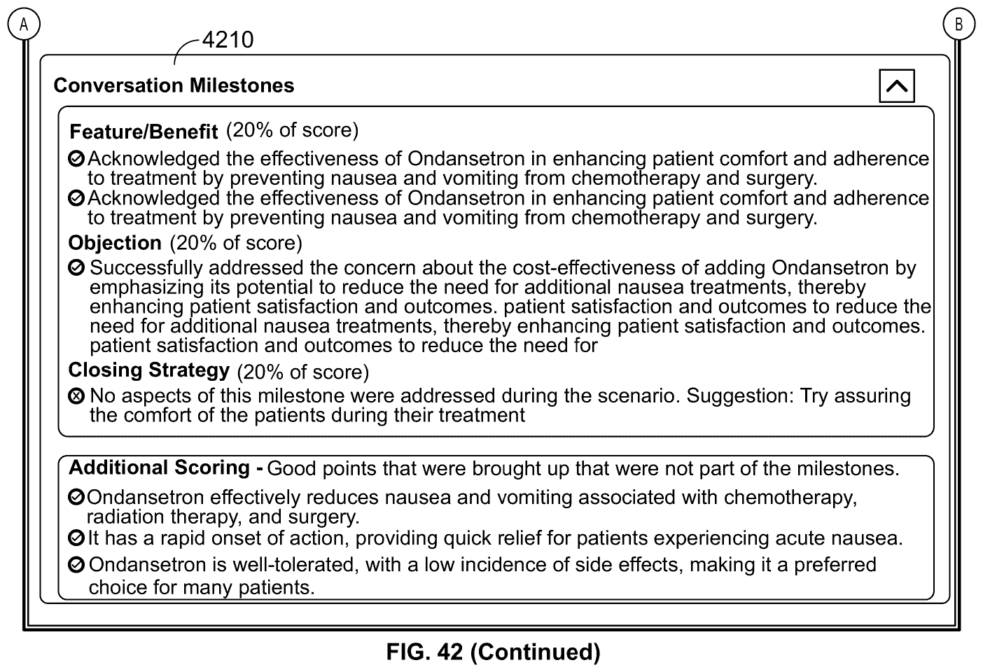

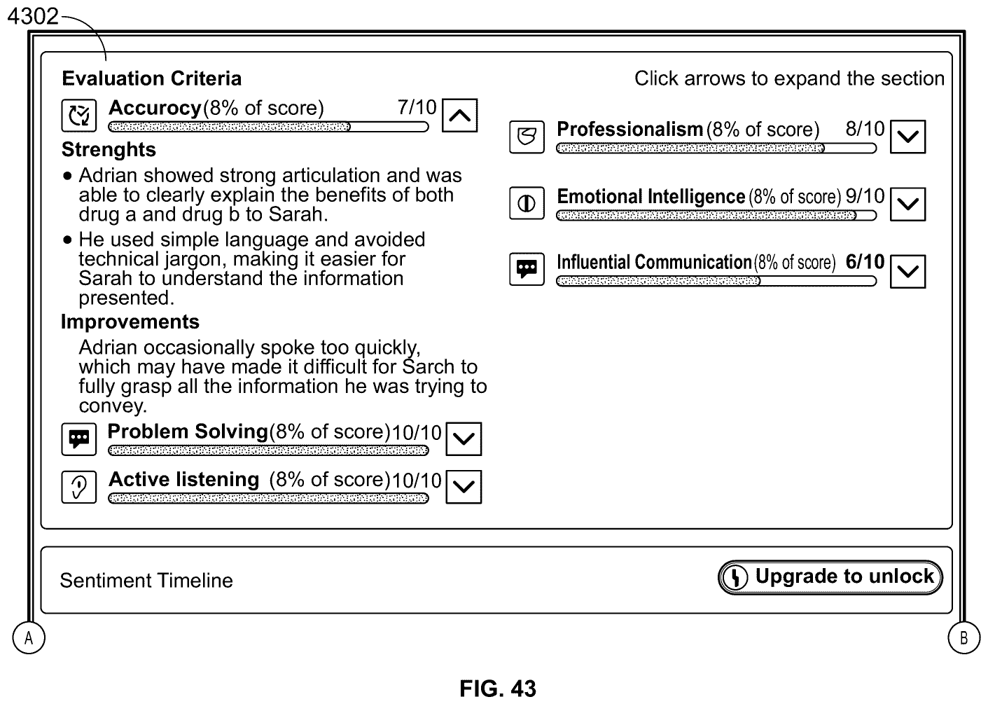

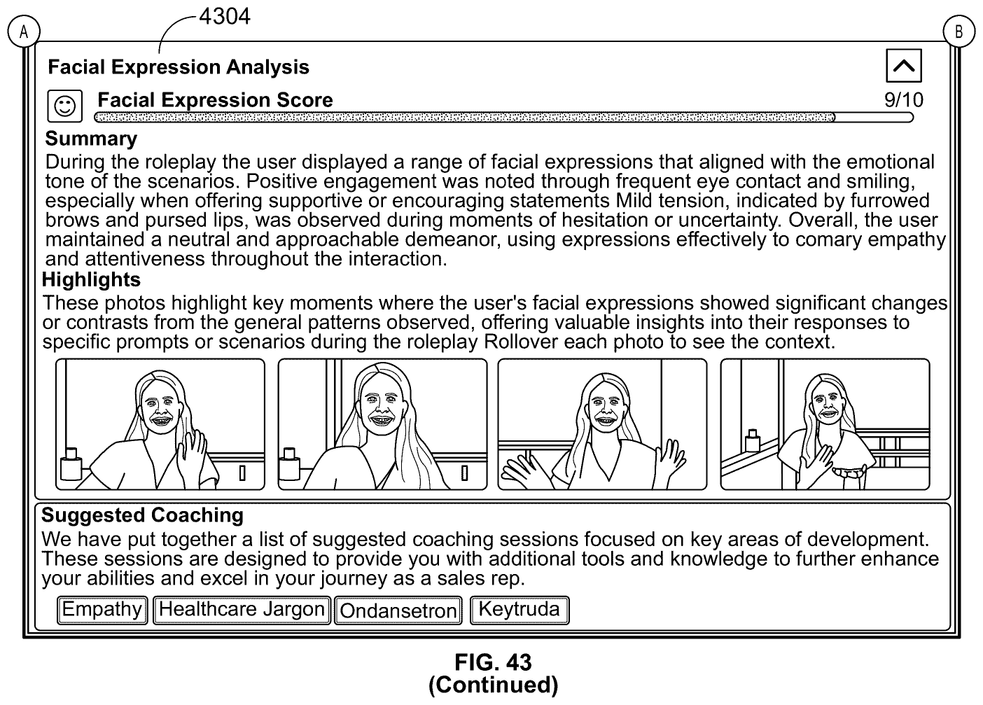

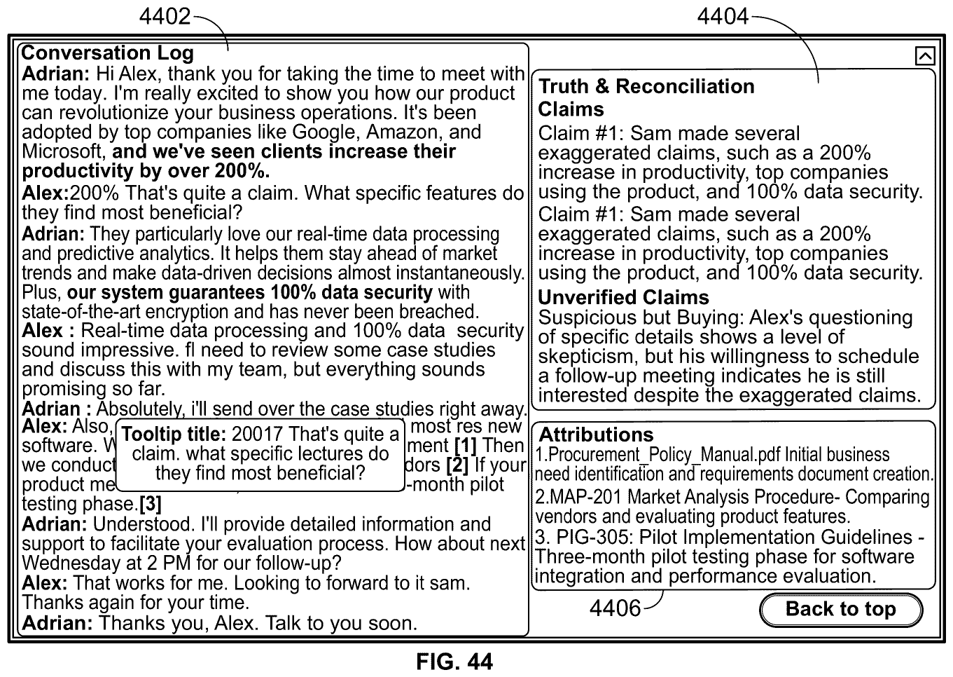

As shown in FIGS. 42-44, the feedback provided by the coaching module may include a summary of the scenario completed by the user 4208, an overall performance score 4202, specific observations 4204 regarding the user's 160 interaction with the chatbot 130, a breakdown of the overall score 4202 based on conversation milestones 4210 and evaluation criteria 4302, a facial expression analysis 4304 of the user 160 during the scenario 120, a conversation log 4402, and other scenario-specific feedback 4404, 4406.

### Meta-Prompt Functionality

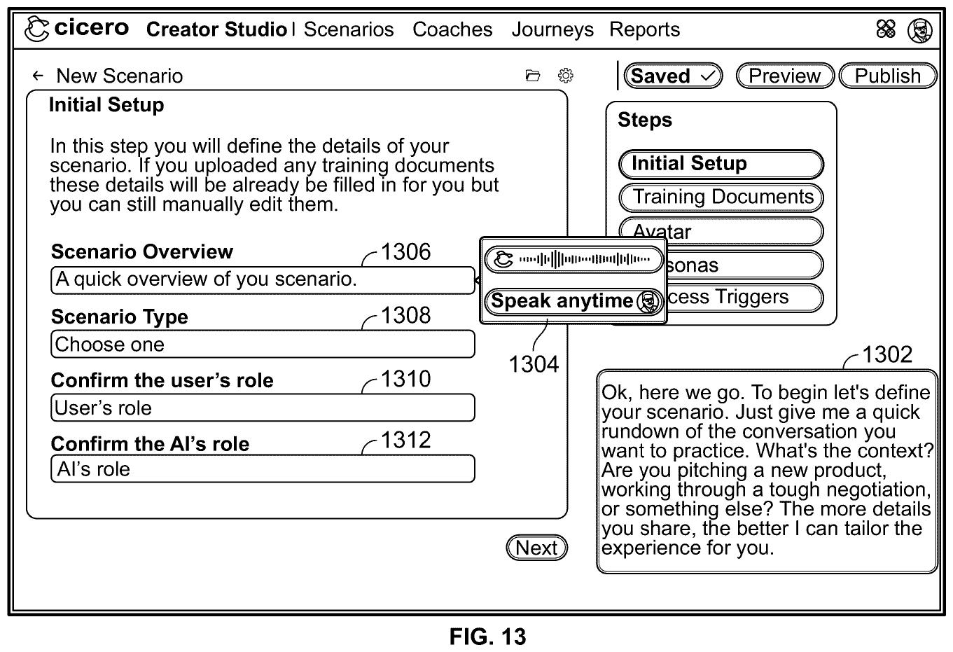

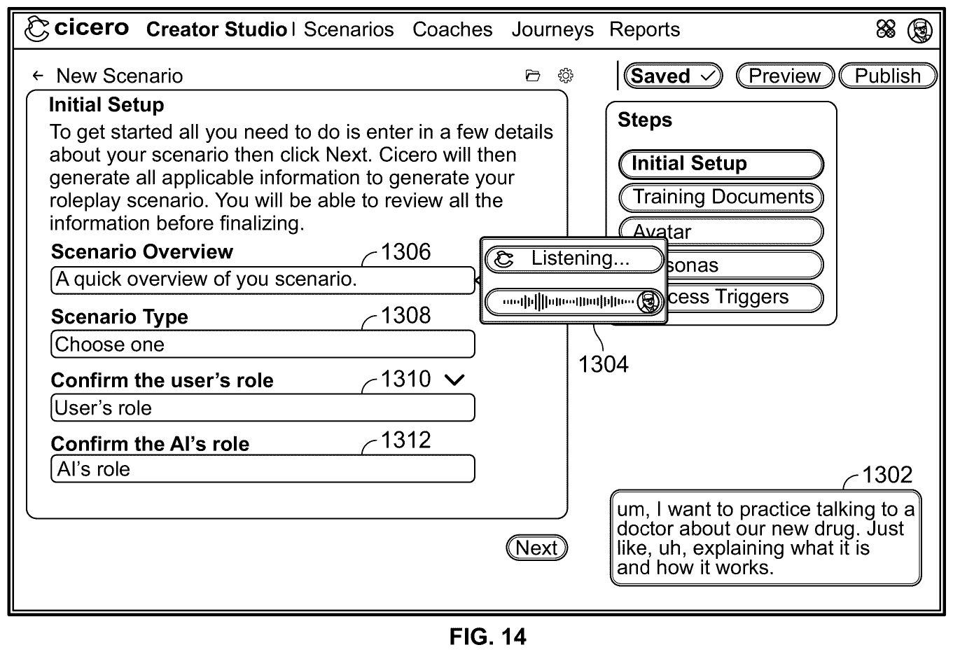

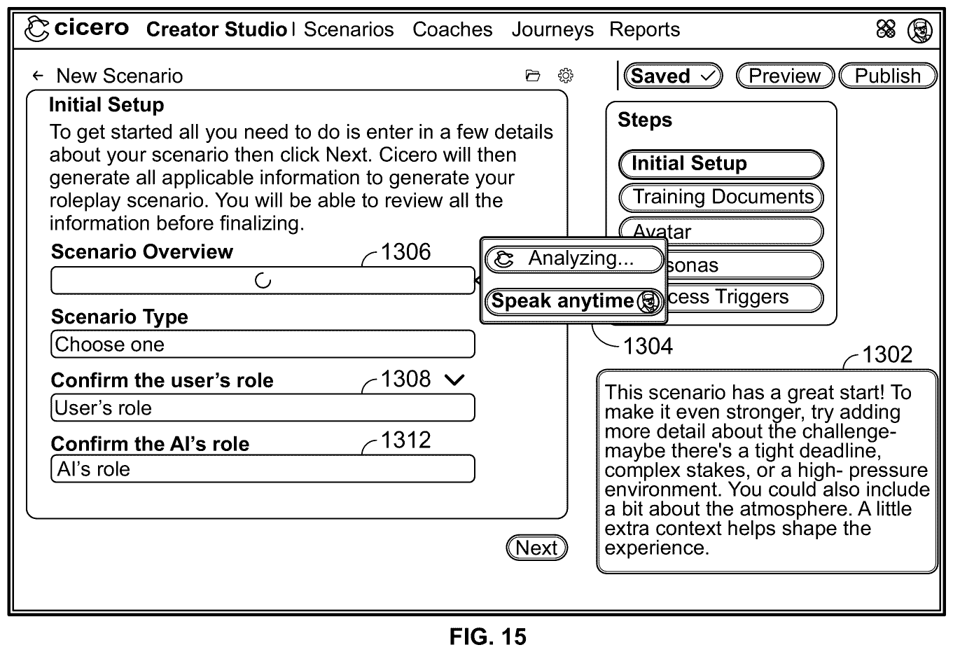

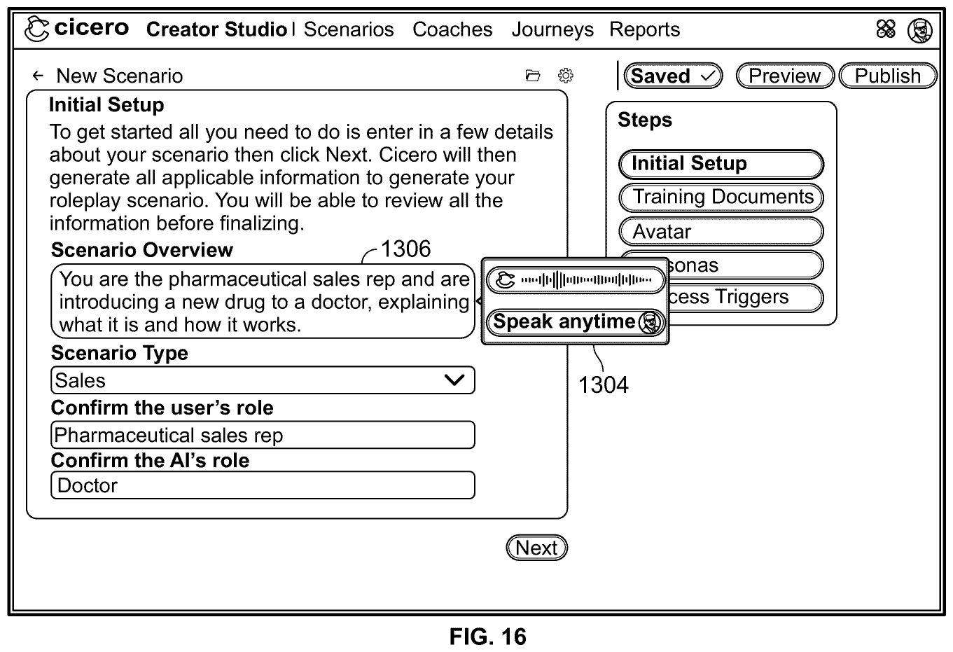

As depicted in FIGS. 13-16, users 160 can create meta-prompts that the disclosed system 100 uses to generate customized soft-skills scenario 120 simulations for any industry. The meta-prompt functionality leverages the machine learning 150 to search relevant knowledge bases 180 and other sources to craft scenarios 120 that are contextually accurate and industry-specific. The disclosed system 100 includes a mechanism for updating and refining these scenarios 120 based on continuous learning from user 160 interactions and feedback with the chatbot 130, which in turn, improves the functionality of the disclosed machine learning model 150.

To generate a basic scenario 120 using the disclosed system 100, the user 160 may include meta-prompts providing a scenario overview 1306 (i.e., a narrative summarizing the scenario), scenario type 1308 (e.g., sales), user's role 1310 (e.g., pharmaceutical sale representative), and AI role 1312 (e.g., doctor).

The ability to customize scenarios 120 through meta-prompt functionality enables users 160 to hone in on developing soft skills most relevant to their field or industry. By iterating through a variety of customized scenarios 120 in a specific field or industry, users 160 can comprehensively develop a well-rounded portfolio of soft skills.

### Voice-Driven Scenario Builder

In one embodiment, users 160 can use a voice-driven scenario builder to create meta-prompts that the disclosed system 100 uses to generate customized soft-skills scenario 120 simulations. The voice-driven scenario builder merges speech recognition, intent extraction, and dynamic form filling using dual-mode speech-to-text and natural language authoring. Through the voice-driven scenario builder, users 160 may convert their speech into meta-prompts in real time for scenario 120 generation.

As shown in FIG. 13, the system 100 of the present disclosure also generates alerts 1302 instructing the user 160 how to use the voice-driven scenario builder and providing feedback on the prompts generated by the user 160.

Additionally, the voice-driven scenario builder provides a listening indicator 1304 showing users 160 when they are being recorded. Once voice instructions are recorded, they are populated in the appropriate scenario-building inputs 1306, 1308, 1310, 1312.

### Fast Mode Scenario Builder

In one embodiment, users 160 may select a fast mode of scenario building 1004. In fast mode, the user 160 provides basic details regarding the scenario 120 they wish to generate. From these details, the disclosed system 100 leverages the machine learning 150 to search relevant knowledge bases 180 and other sources to craft a fully playable scenario 120 with avatar 512 feedback in minutes.

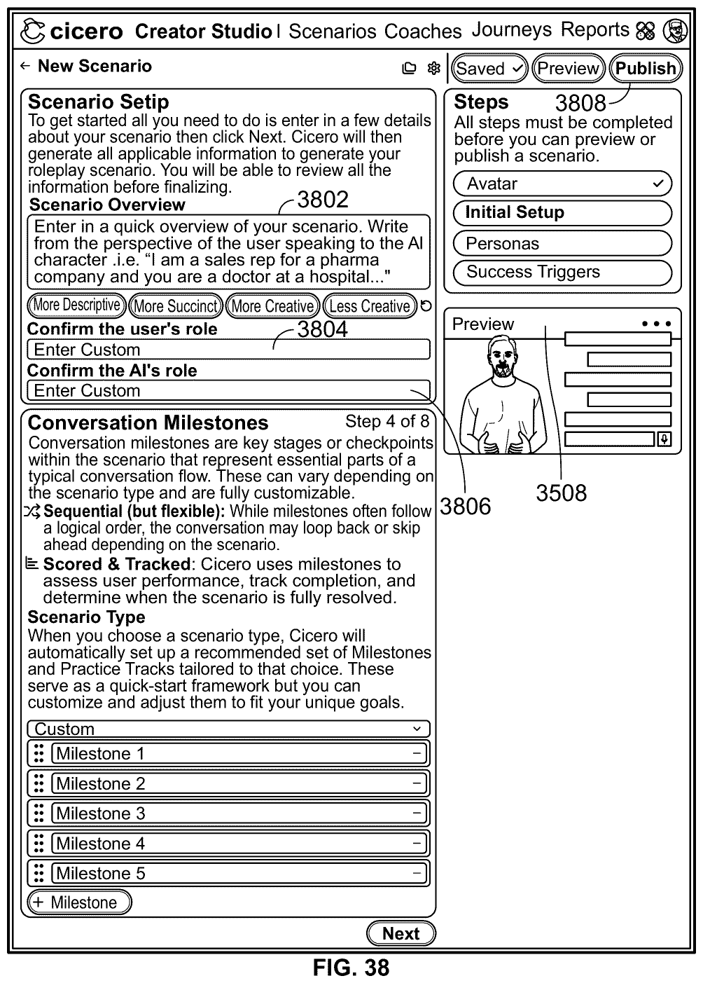

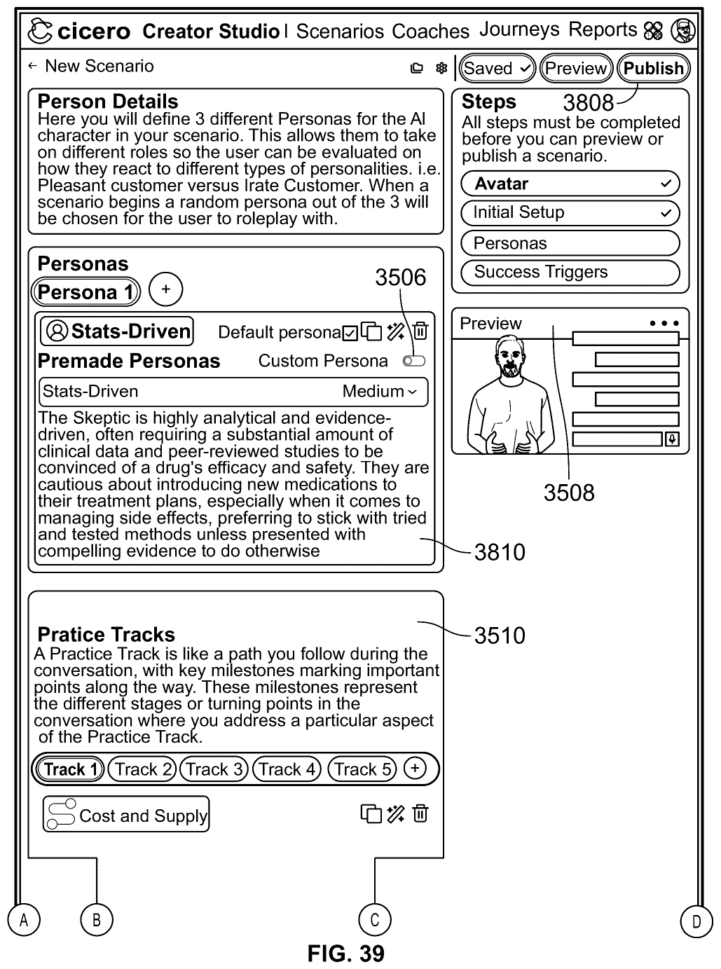

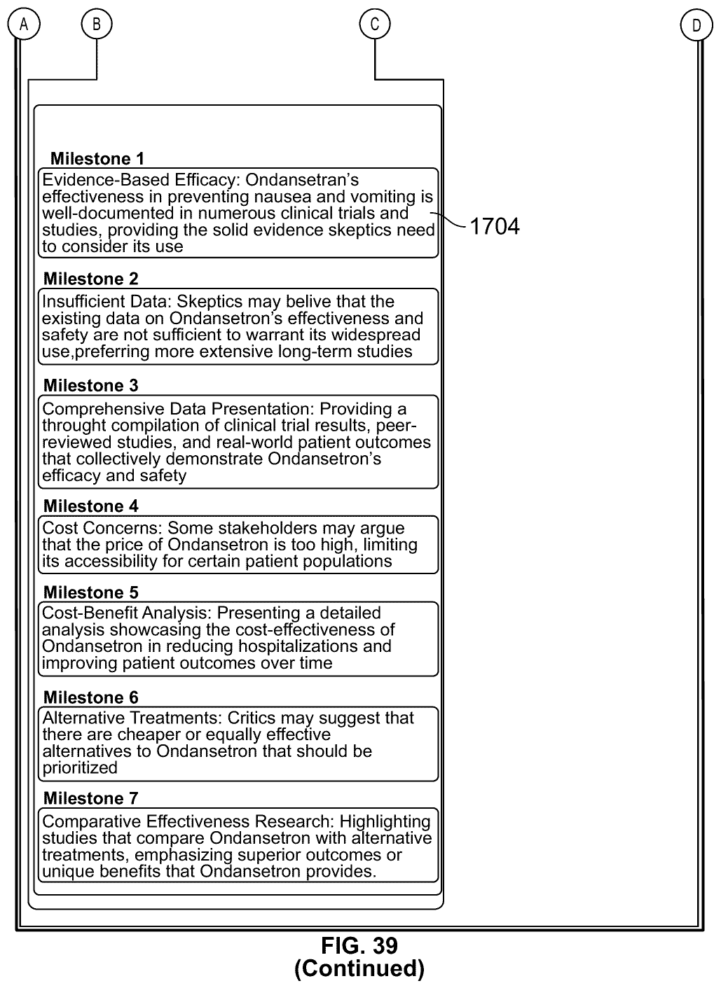

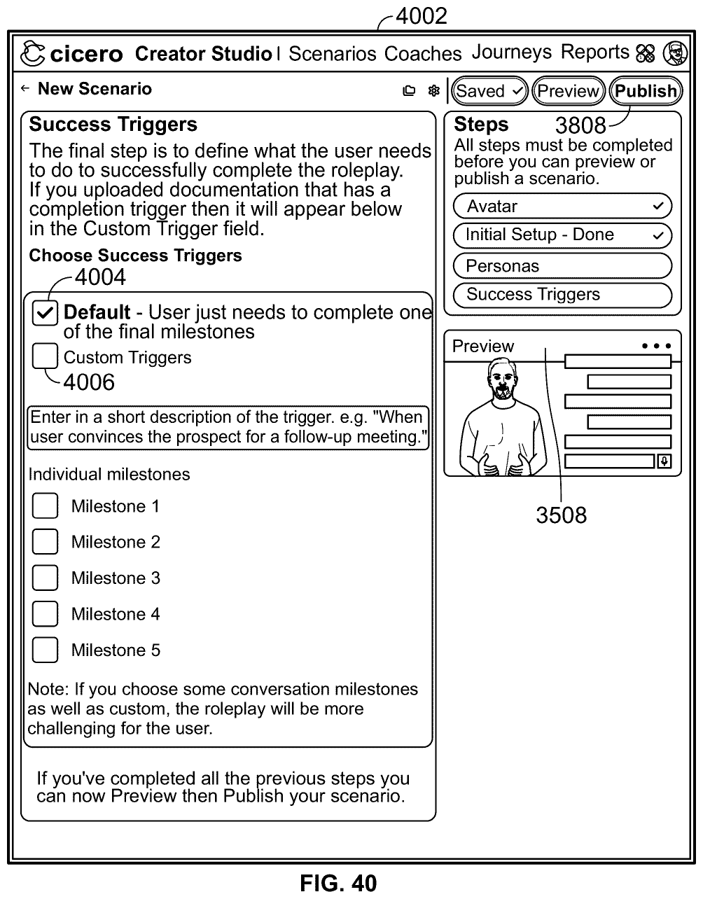

As shown in FIGS. 38-40, fast mode scenario generation includes providing the system 100 with a scenario overview 3802, the user's role 3804 in the scenario 120, the AI's role 3806 in the scenario, and conversational milestones 1704 (discussed in more detail below). The user 160 can also provide the system 100 with success triggers 4002 which define what a user 160 must do to successfully complete a scenario 120. The user 160 has the option to select a default success trigger 4004 (e.g., completion of the final milestone) or set custom success triggers 4006 (e.g., completion of other specific milestones).

To aid the fast mode scenario builder, the user 160 may upload supporting training materials. These training materials may aid the fast mode scenario builder in scenario 120 generation by providing relevant details such as information concerning the user's 160 organization, products, and goals. The training materials may also include evaluation documents to aid the fast mode scenario builder in evaluating the user 160 upon scenario 120 completion.

As depicted in FIG. 13, the voice-driven scenario builder 510 may be used in conjunction with the fast mode scenario builder.

### Multi-Provider LLM Router

In one embodiment of the disclosed system 100, users 160 can swap between different LLM models supporting the chatbot 130 such as OpenAI and Grok 3. This allows users 160 to customize their experience by taking advantage of the unique strengths of different language models. For instance, a user 160 could select a LLM model known for producing more conversational and creative content or one known for providing detailed, logical responses.

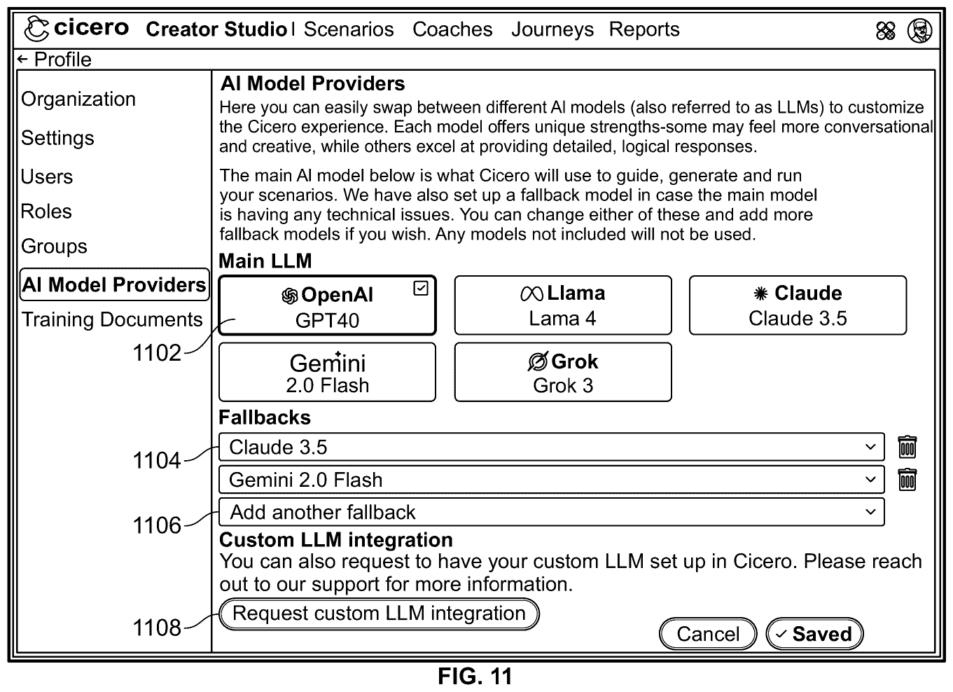

As shown in FIG. 11, users 160 can select fallback LLM models 1104 which the disclosed system 100 will automatically use in case the main LLM model 1102 experiences technical issues. Users 160 have the option to select multiple fallback LLM models 1106. A user 160 may also request to have a custom LLM set up to be used by the system of the present disclosure 1108. Together, these features materially improve the AI uptime and cost stability of the disclosed system 100.

### Dynamic Milestone Framework

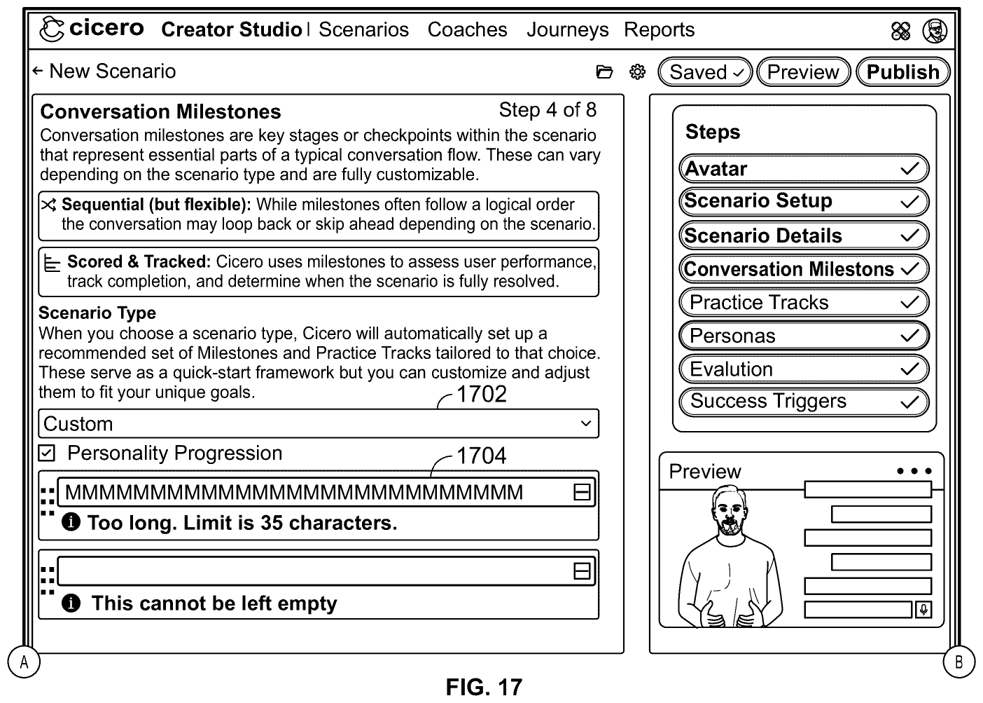

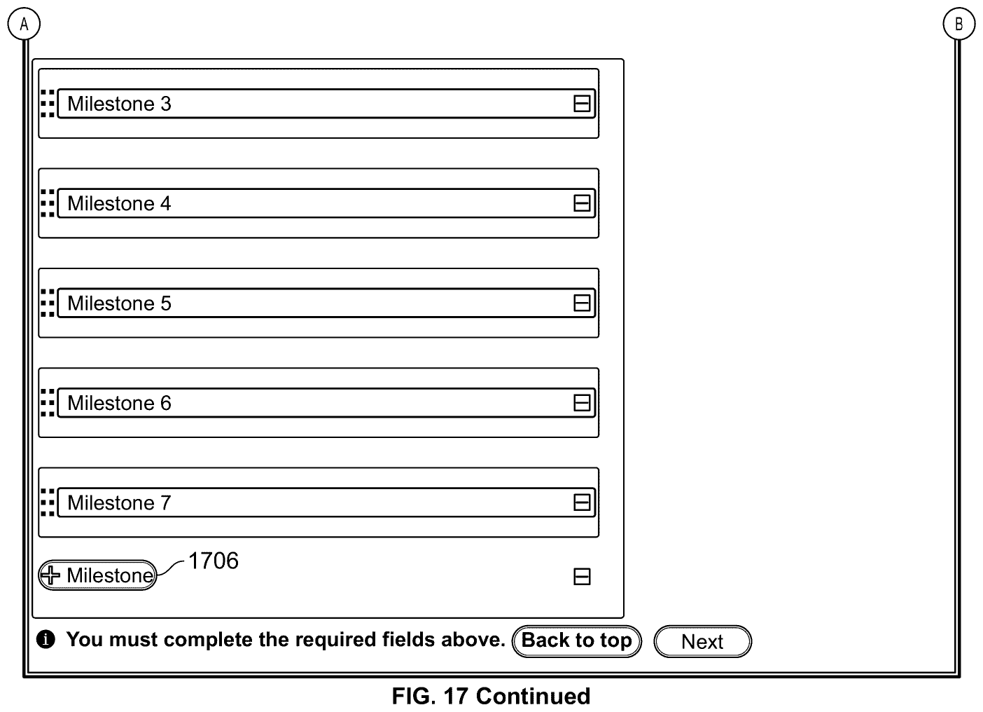

In another embodiment of the disclosed system 100, users 160 may input conversation milestones 1704 when building a scenario 120 as depicted in FIG. 17. Conversation milestones 1704 are key stages or checkpoints within the scenario 120 that represent essential parts of a typical conversation flow, which vary depending on the scenario type.

When a user 160 selects a scenario type 1308, the disclosed system 100 will automatically set up a list of recommended conversation milestones 1704 and practice tracks 3510 tailored to that choice. These automatically-generated milestones serve as a quick-start framework but can be customized 1702 by the user 160 to fit their unique goals.

Conversation milestones typically track a logical order but the user's 160 conversation with the chatbot 130 may skip ahead or loop back to address certain conversation milestones 1704 depending on the scenario 120. The disclosed system 100 uses these conversation milestones to assess user performance, track scenario 120 completion, and determine when the scenario 120 is fully resolved.

### Avatar Creation

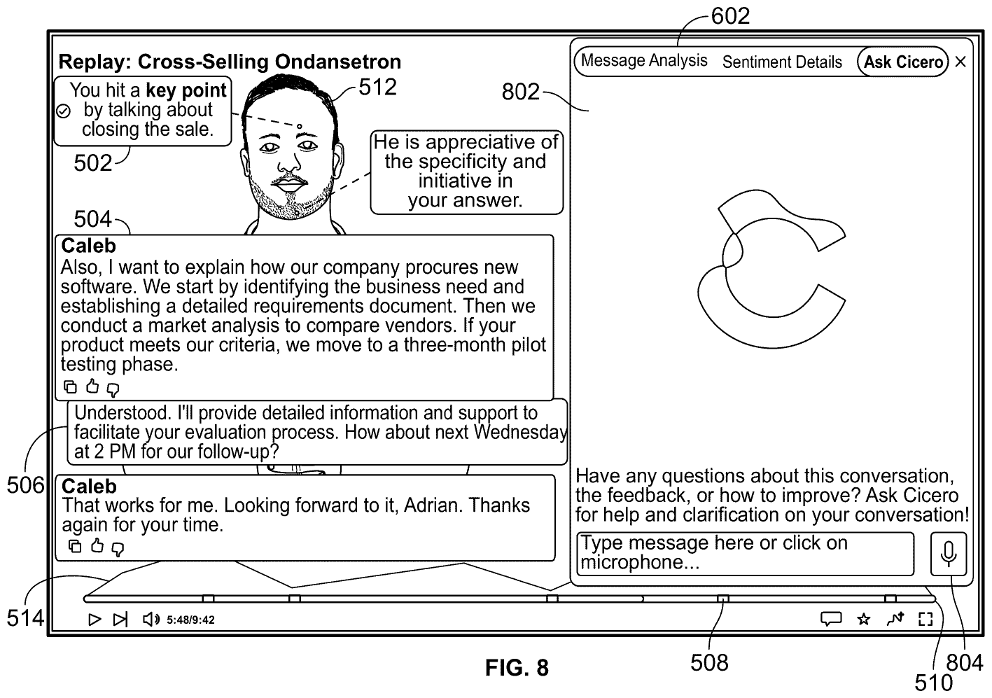

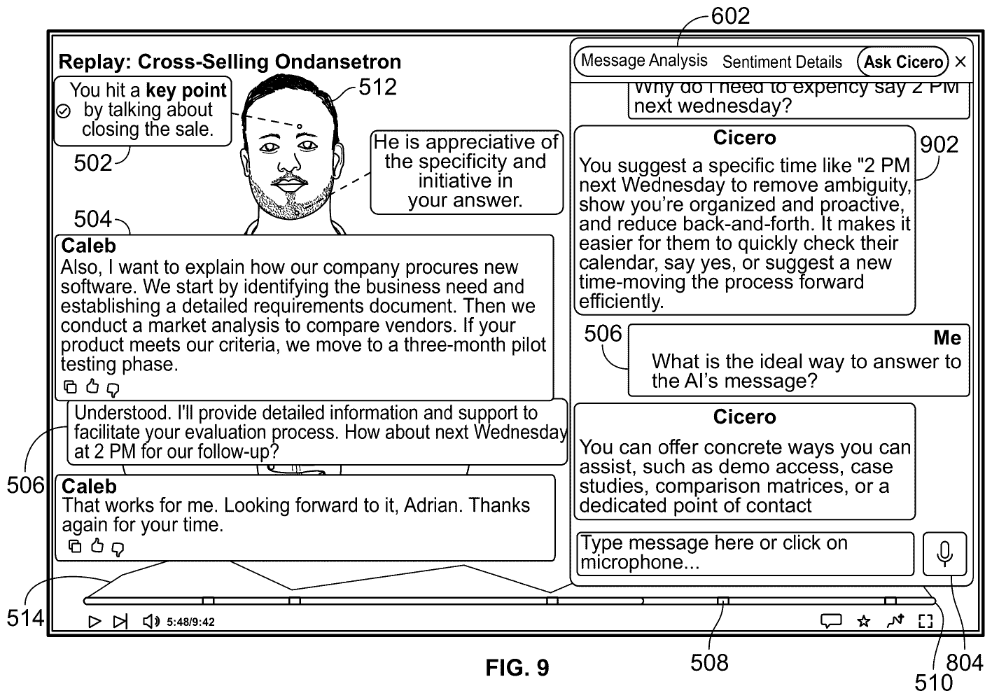

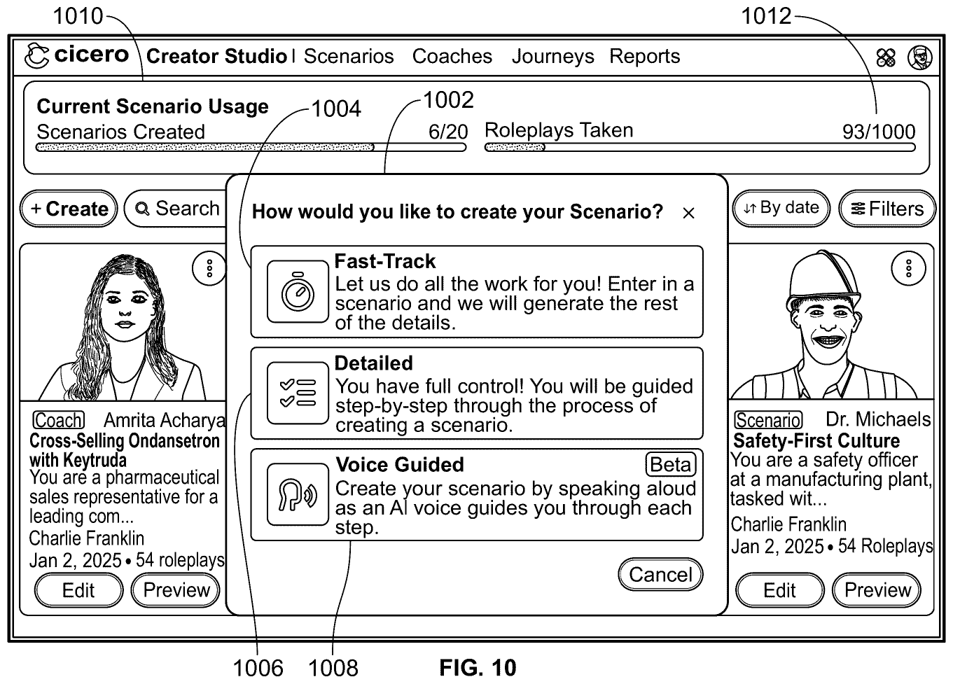

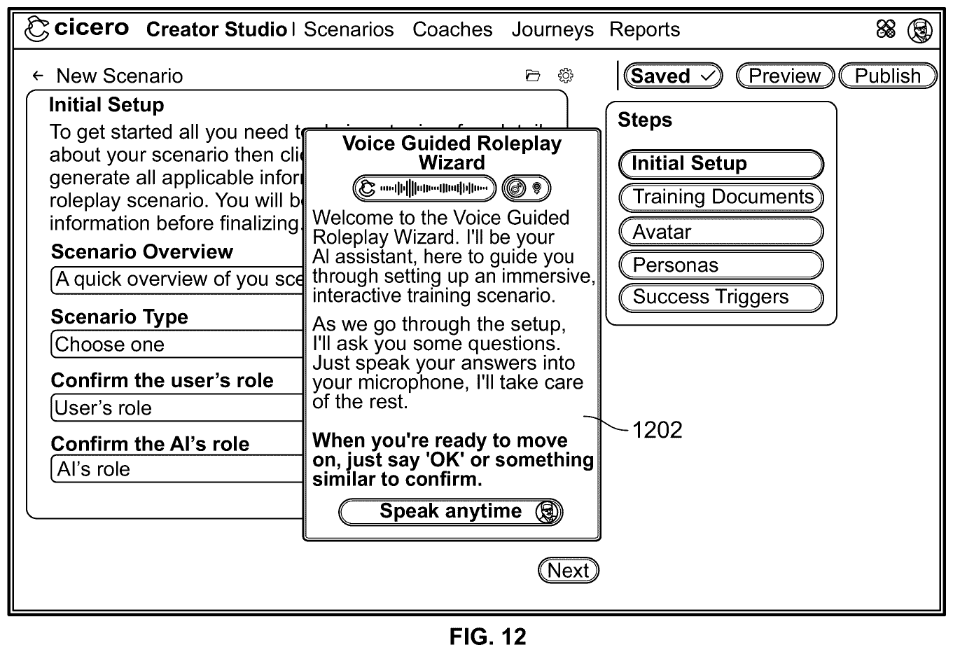

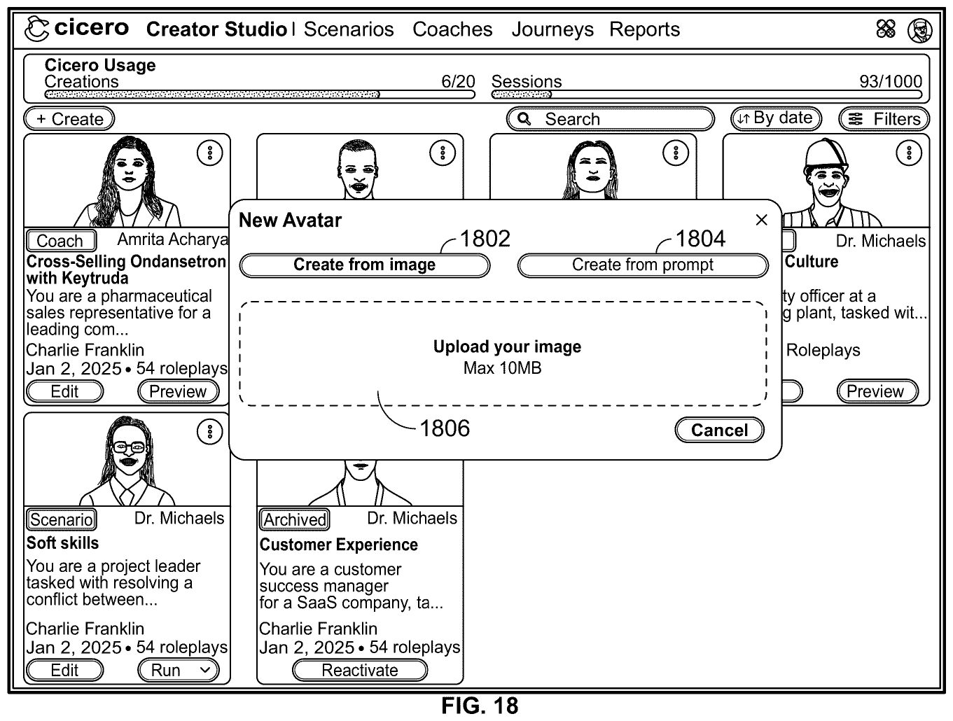

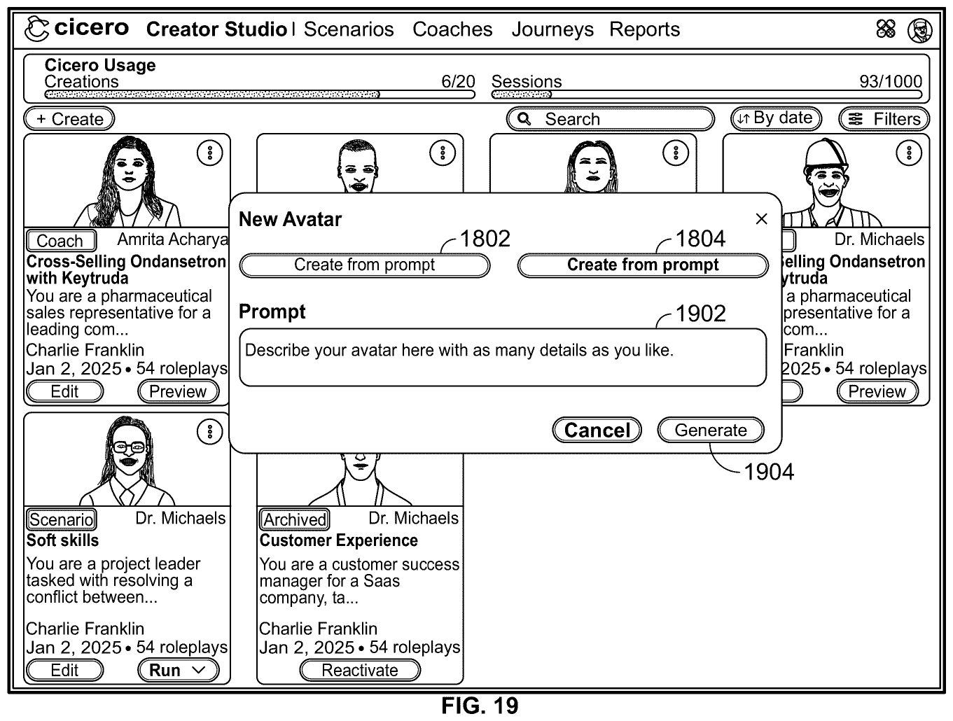

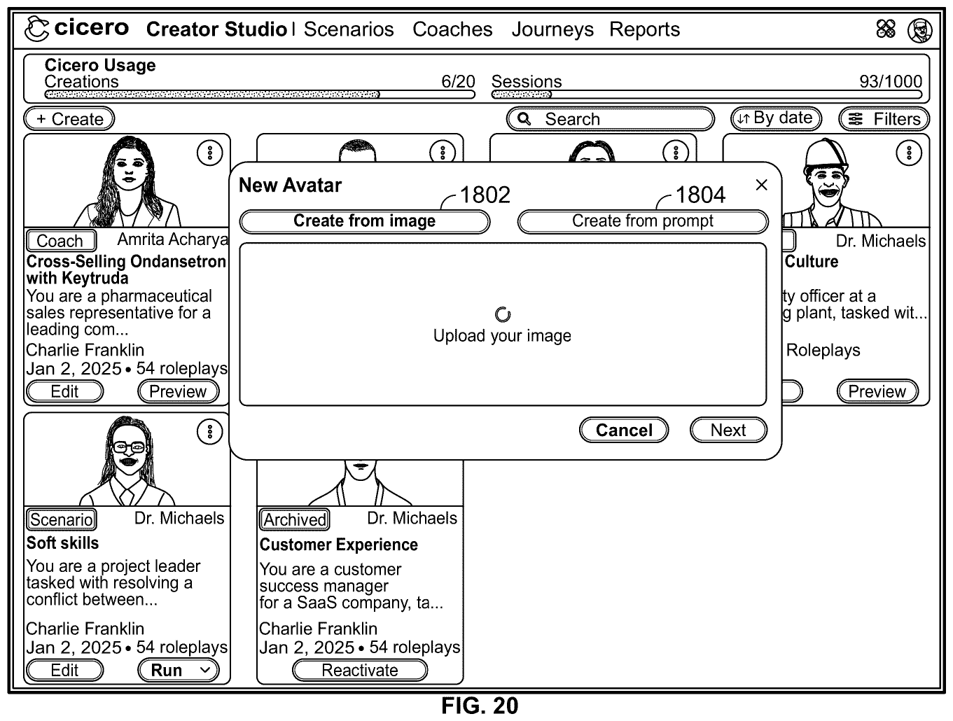

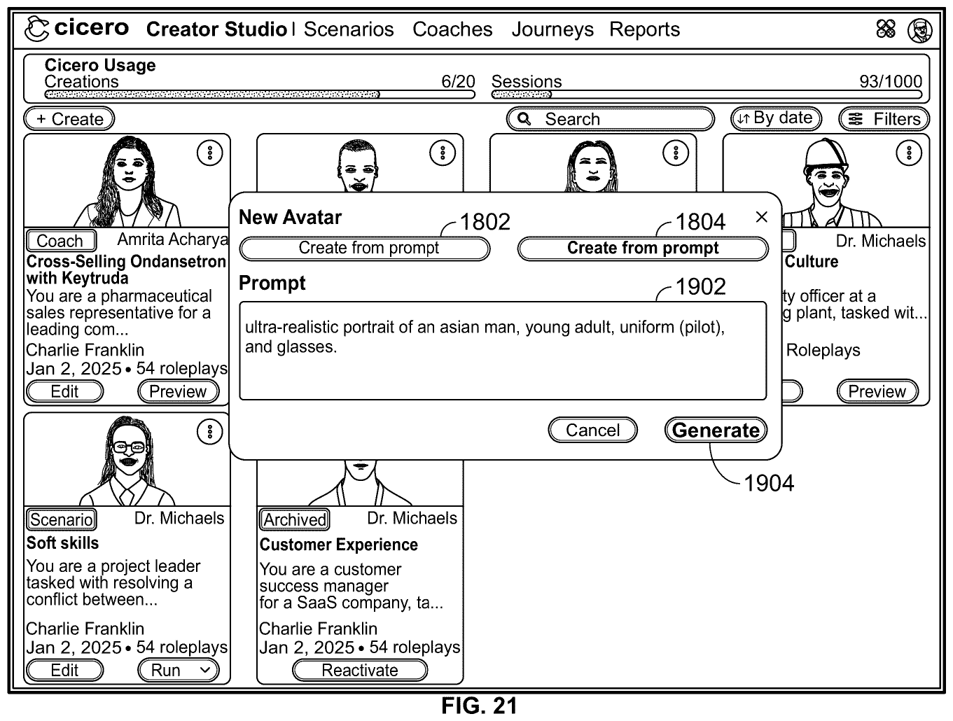

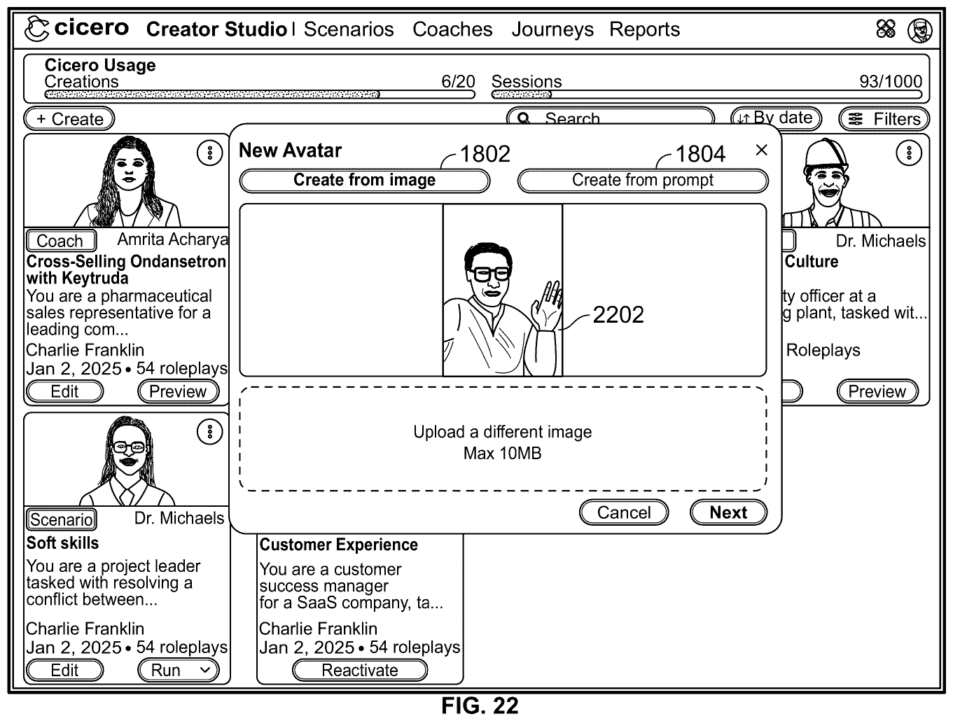

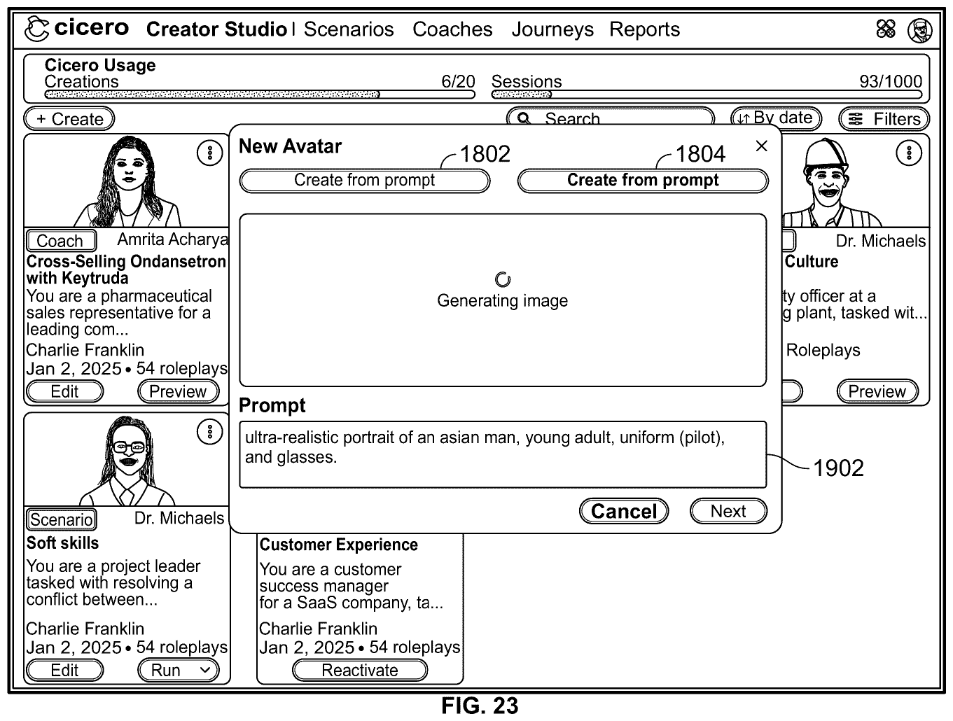

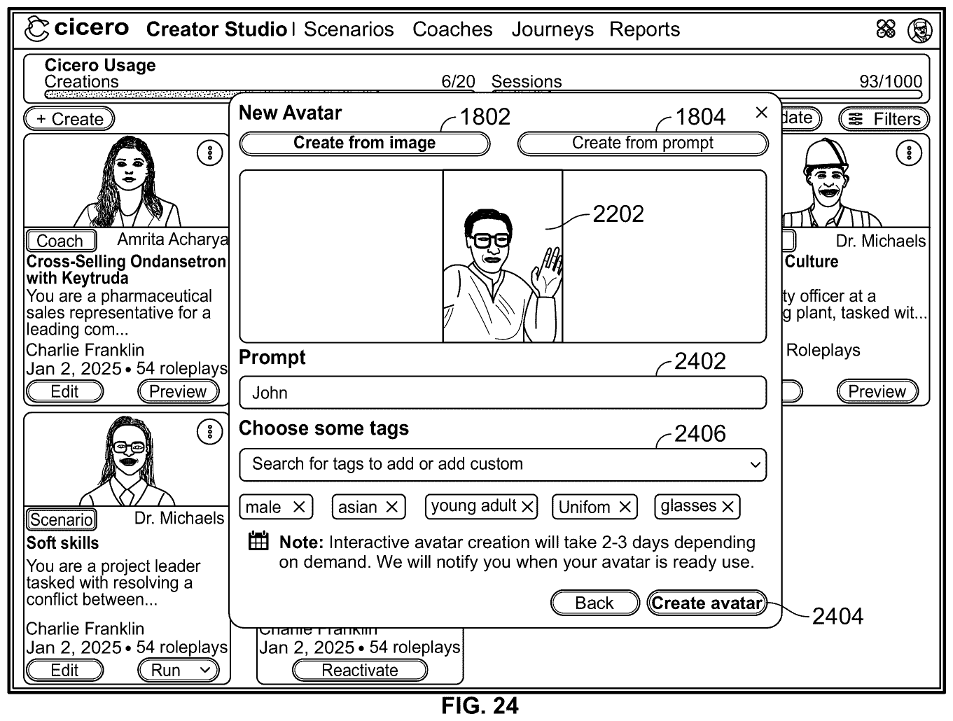

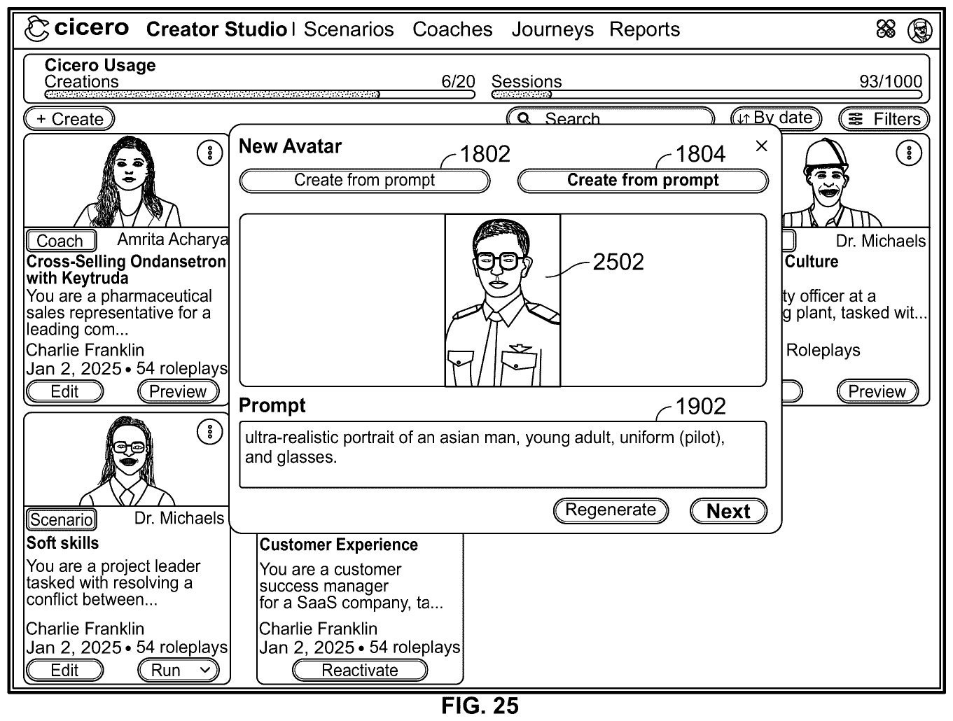

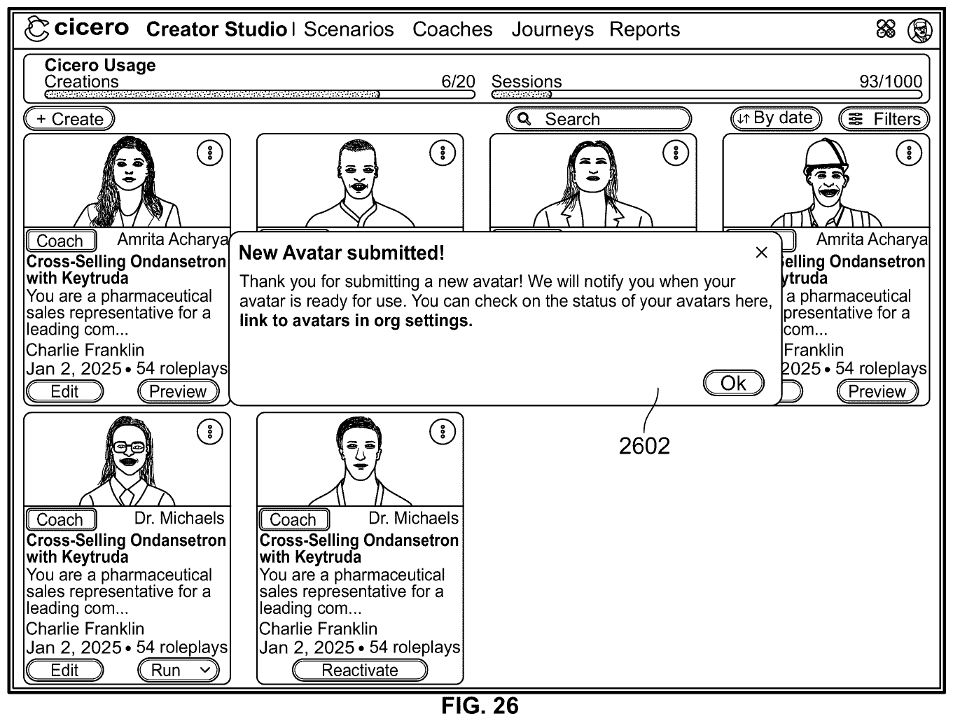

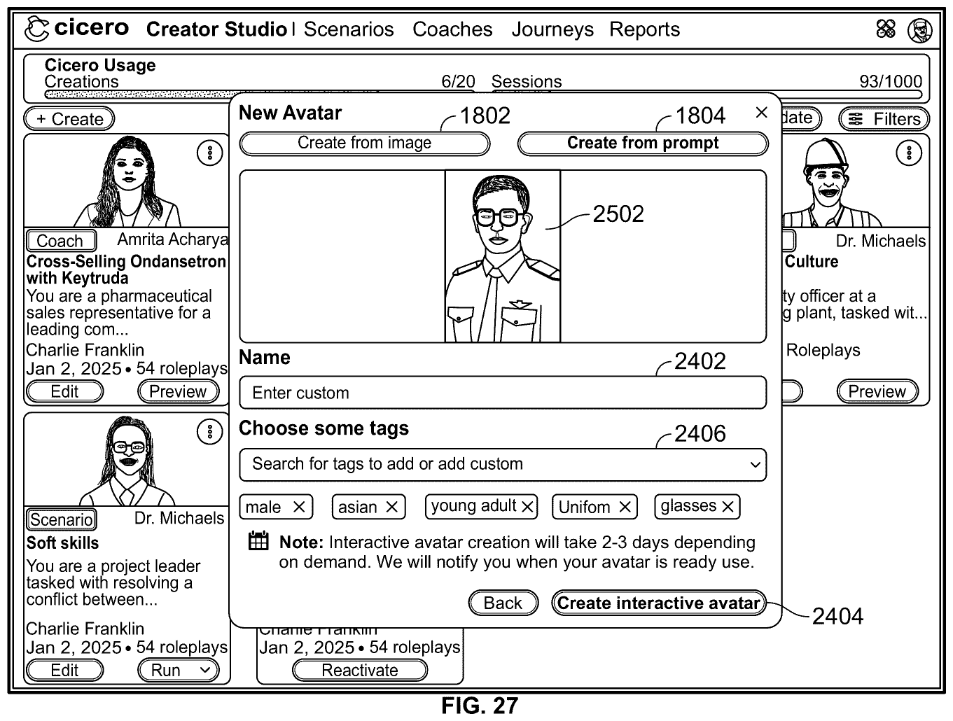

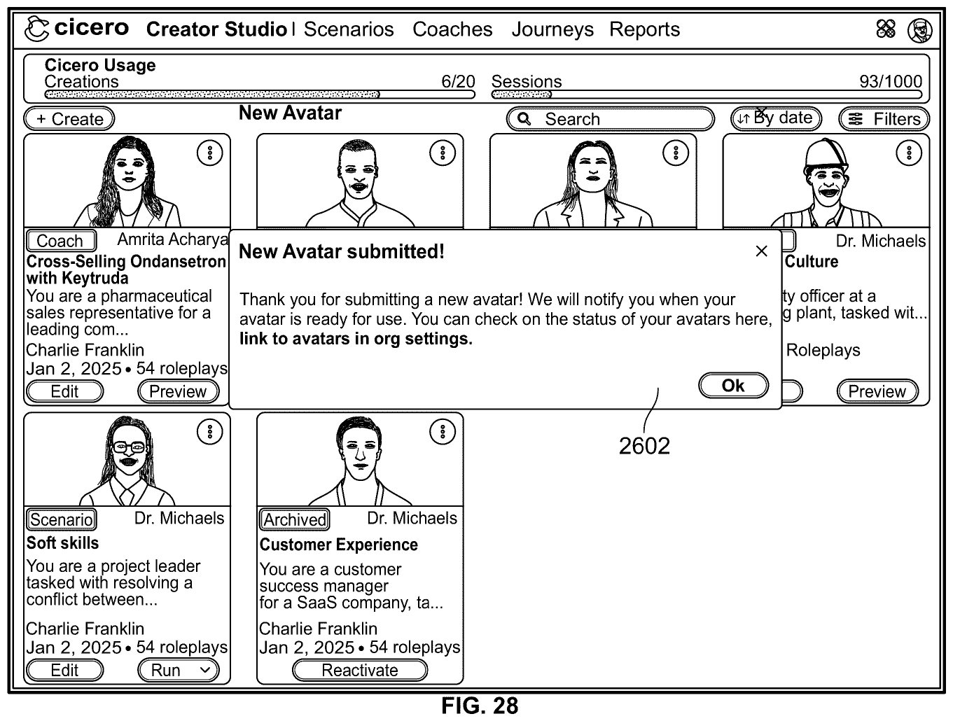

As depicted in FIG. 5, the chatbot 130 may be personified by an avatar 512. FIGS. 8-18 depict alternative routes for generating the avatar 402 using the disclosed system 100. A user is given the option to create an avatar 512 from an image 1802 or from a user-generated prompt 1804.

The first route for avatar 512 generation includes uploading an image to a space 1806 180 from which the system 100 can create an avatar 512. Once the image has been uploaded 2202, the user 160 can name the avatar 512, 2402. The user 160 can also tag 2406 the avatar 512 according to certain characteristics (e.g., male, young, or glasses) for efficient organization among all the avatars 512 generated by a user 160. Next, the system 100 utilizes robotic process automation which links to external API for avatar 512 generation.

The second route for avatar 512 generation leverages the machine learning 150 to generate an image from a user prompt 1902, 1904 (e.g., “ultra-realistic portrait of an Asian man, young adult, uniform (pilot), and glasses”). Once the image 2502 is generated, the user 160 can name the avatar 512, 2402. The user 160 can also tag 2406 the avatar 512 according to certain characteristics (e.g., male, young, or glasses) for efficient organization among all the avatars 512 generated by a user 160. Next, the system 100 utilizes robotic process automation which links to external API to generate the avatar 512.

Once the user 160 has completed one of the routes for avatar 512 generation, the user 160 will receive an alert 2602 that their new avatar has been submitted, ready to be used in scenario 120 building.

The methods for generating an avatar 512 avoid any manual digital-content creation and allow users 160 to customize their experience.

### Multi-Participant Real-Time Conversation

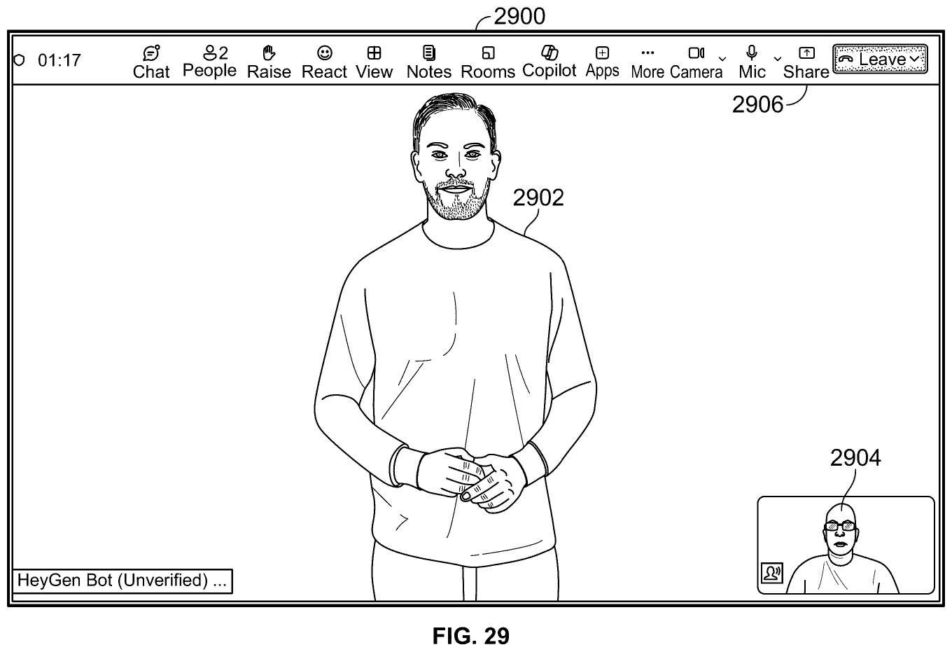

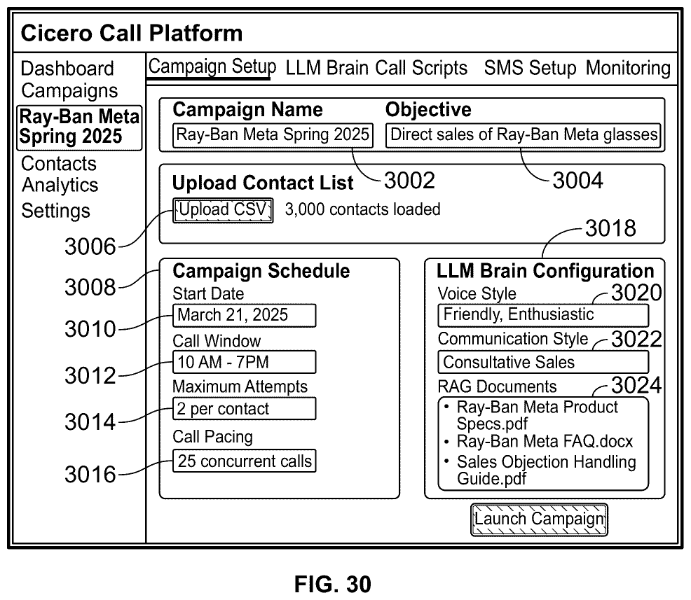

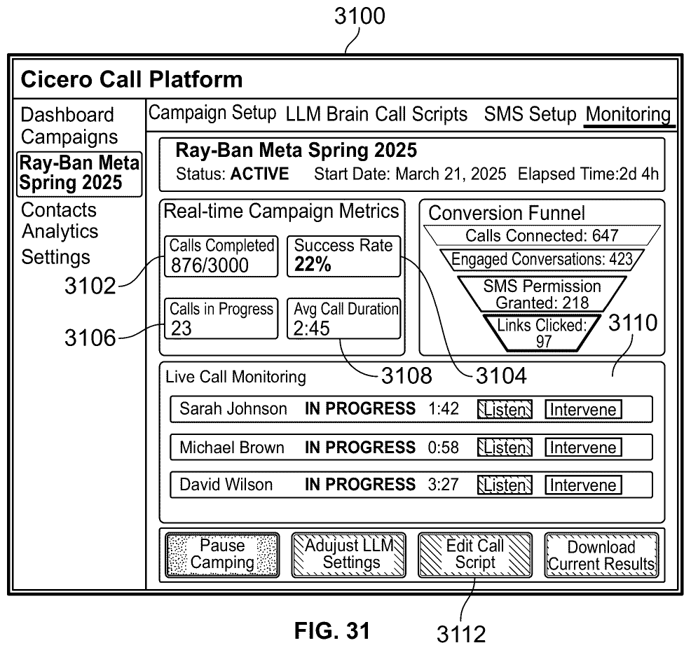

In one embodiment, as shown in FIG. 29, the disclosed system 100 includes a WebRTC chatroom 2900 where multiple humans 2904 and AI agents 2902 can engage in conversations, share live streams, and perform on-the-fly document/video analysis.

Sessions between the human(s) 2904 and the AI agent 2902 may be either voice-only or include a video chat component, in which case the AI agent 2902 will be personified by an avatar 512. Such sessions may also include multiple AI Agents 2902 which may have different perspectives and personalities from one another.

Both voice-only and video sessions between the humans(s) 2904 and AI agent(s) 2902 include live media sharing 2906, document analysis, screen sharing, and collaborative interactions. The system 100 leverages the machine learning 150 to analyze the speech of and media shared by the human(s) 2904. Based on these readings, the AI Agent(s) 2902 is enabled to provide the human(s) 2904 with real-time guidance, education, and training on a variety of topics, including those related to the human's 2904 soft skill development.

### AI Dialing and Conversation Engine

In a further embodiment, the disclosed system 100 includes an AI dialing and conversation engine. Through use of this engine, users 160 can task AI agents with making sales calls.

FIG. 30 shows the user interface 105 a user 160 may use to deploy these AI agents for sales calls. Specifically, the user interface 105 for the AI dialing and conversation engine enables users to create different sales campaigns 3002 with different objectives 3004 (e.g., direct sales of Ray-Ban Meta glasses). The user 160 may also upload a contact list 3006 of individuals to be called, designate a campaign start date 3010, set the call pacing of the AI agents 3016 along with the maximum number of times a particular phone number will be dialed 3014, and determine time windows 3010 during which the AI agent will make sales calls.

The user interface 105 also allows users 160 to configure the “brain” 3018 of the AI agents making the sales calls to use a certain voice style 3020 (e.g., friendly or enthusiastic) or communication style 3022 (e.g., consultative sales). The user 160 may also upload training materials 3024 enabling the AI agents to learn relevant information regarding selling tactics and the product being sold.

The user interface 105 of the AI dialing and conversation engine further includes an analytics page 3100 which provides the user 160 with information on the number of calls made 3102 made in a given campaign 3002, the overall success rate of the calls 3104, the number of calls in progress 3106, and the average duration of each call 3108. The analytics page 3100 also includes a live call monitor 3110 and an “edit call script” button 3112 enabling users 160 to track the AI dialing and conversation engine in real time and to edit the dialogue used by the AI agents on sales calls.

### AI Video-Podcast Maker

In an embodiment, the disclosed system 100 includes an AI video-podcast maker which turns text lessons into multi-host video podcasts with synchronized slides.

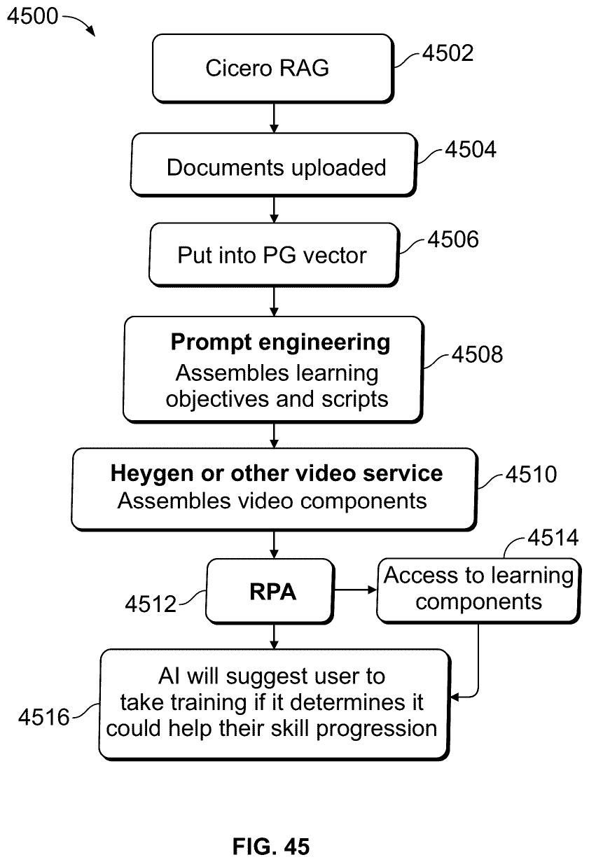

As shown in FIG. 45, the process 4500 begins with a user 160 accessing the RAG platform 4502 which is capable of processing user 160 input for the AI video-podcast maker. The process then proceeds with the user 160 uploading documentation 4504 to the AI video-podcast maker user interface 105. The documentation may include items such as training guides or sales manuals which provide the informational foundation of the video-podcasts ultimately generated. The documents are then put into PG Vector which transforms the documentation into a format which the AI can understand and search through quickly.

Next, the AI video-podcast maker undertakes a prompt engineering process 4508 wherein it builds learning goals and creates training scripts using the uploaded documentation. The script is then turned into a video with an AI avatar 512 for viewing.

Lessons are then delivered to the user 160 as needed through robotic process automation (RPA) 4512, thereby providing the user 160 with easy video access to the learning components of the uploaded documentation 4514. If the AI video-podcast maker system discovers that the user 160 is missing or could improve upon a skill, the user 160 is prompted with suggested trainings and links thereto 4516.

This feature avoids writing, scene scheduling, voice casting, and other costs typically associated with the production of educational video content.

### Multi-Dimensional Skill Tracker

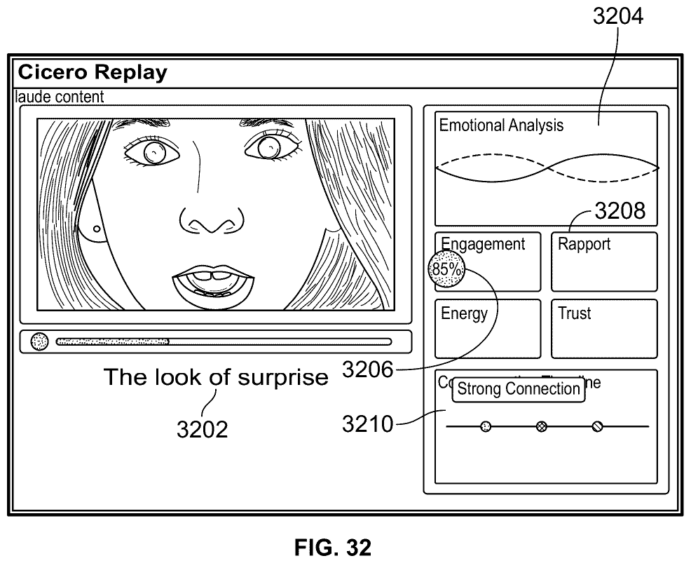

In another embodiment, as shown in FIG. 32, the disclosed system 100 features a multi-dimensional skill tracker which can be used to analyze emotional variables such as rapport, dominance, impatience, and knowledge recall over multiple scenario 120 simulations with the chatbot 130. The multi-dimensional skill tracker assigns these emotional variables 3210 a percent score based on the user's 160 performance in a scenario 120, which are in turn reflected in an analytics dashboard 3208. These scores can also be plotted on a longitudinal tracking curve 3204 to facilitate the user's 160 interpretation thereof.

The multi-dimensional skill tracker further comprises a connection timeline 3210 which measures the user's ability to connect with the chatbot 130 at a given point in the scenario. An image pane also shows reflects the facial expressions of the user 160 through a scenario 120 and provides an analysis thereof 3202.

### Personality Fine-Tuner for AI Opponents

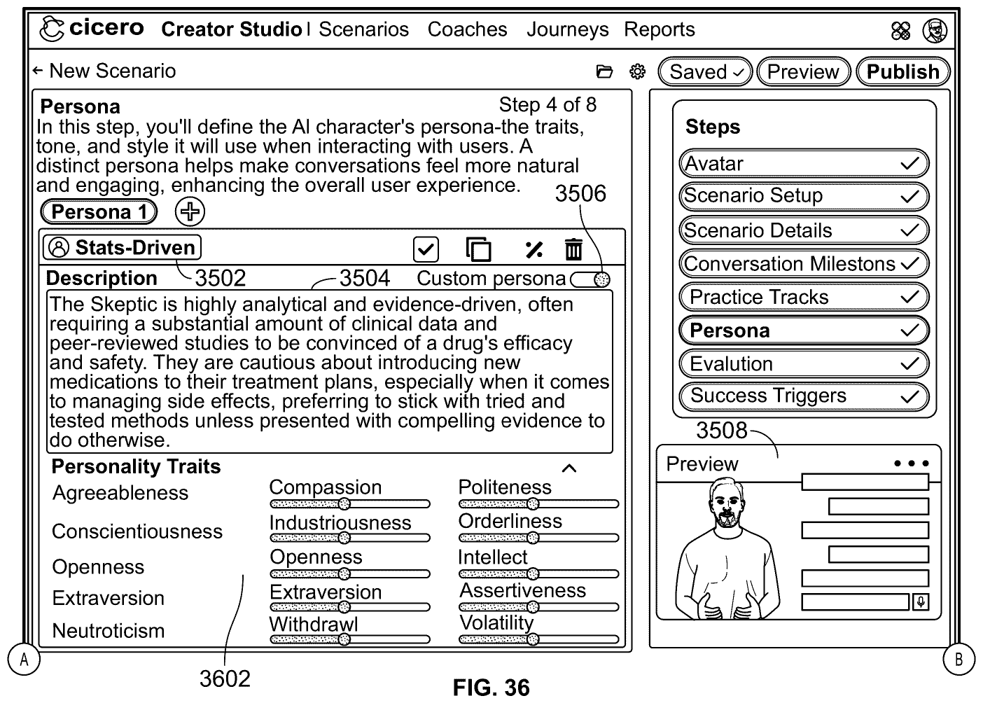

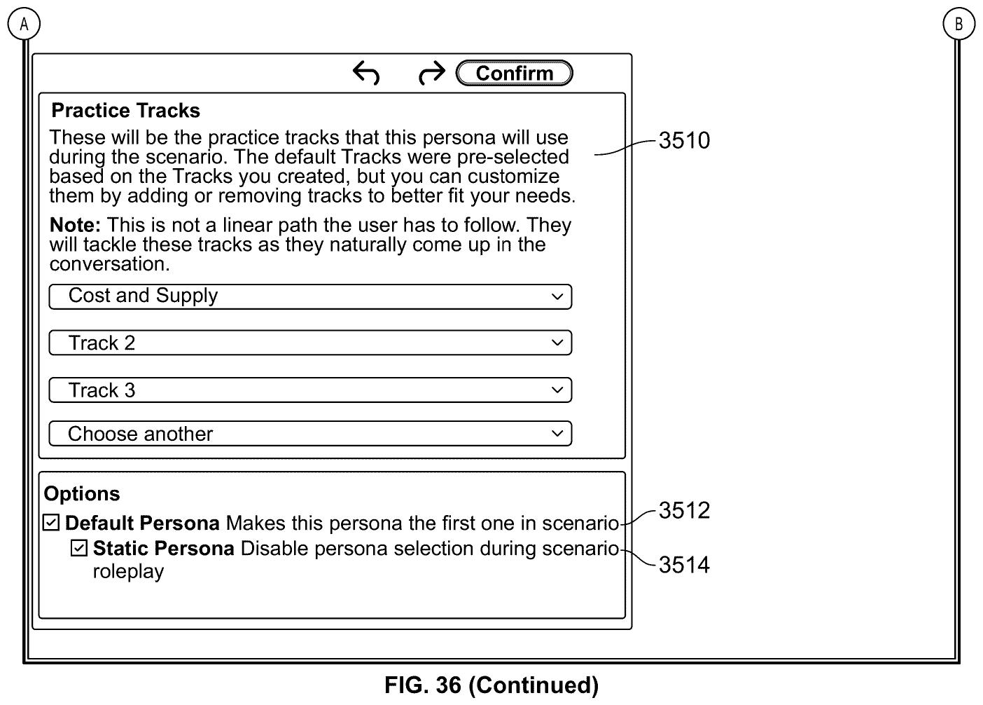

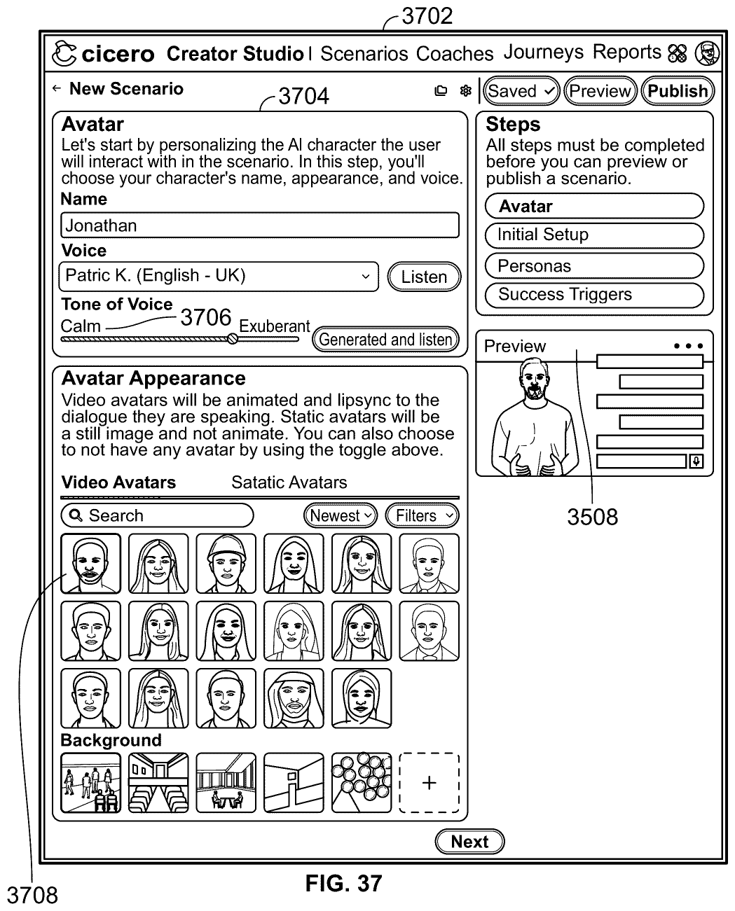

In an embodiment, the user 160 has the option to customize 3506 the personality traits of a chatbot 130 in a scenario through the use of psychometric sliders 3602. As shown in FIG. 36, there are five broad characteristics which may adjusted using psychometric sliders: agreeableness, conscientiousness, openness, extraversion, and neuroticism. These broad categories each further delineated into two subcategories: compassion and agreeableness, industriousness and orderliness, openness and intellect, enthusiasm and assertiveness, and withdrawal and volatility, respectively.

These psychometric sliders 3602 allow users 160 to generate bespoke AI personas and fine-tune dialogue in minutes. This customization further allows users 160 to build scenarios 120 with chatbots 130 having personality traits that the user 160 may have difficulty interacting with, thereby providing users 160 with ample opportunities to develop their soft skills.

Before being adjusted, the psychometric sliders 3602 have an initial position/value based on the user's 160 selection of a general persona 3502 for the chatbot 130 (e.g., a status-driven persona). In addition to customizing the chatbot's 130 persona through the psychometric sliders 3602, users 160 can customize the chatbot's 130 persona by providing the system with a written description 3504 of the persona.

### Integration

The disclosed system and method are integrated with various training platforms to offer a broad array or experiences and training opportunities. For example, a user 160 may access the disclosed system and method 100 via a mobile phone, mobile app, website, virtual reality or augmented reality user interface 105. The user experience is preferable linked across these user interfaces 105 to allow a user 160 to access the training modules as is convenient. User 160 progress is stored in a database 110 to make this possible.

The disclosed system and methods are embodied further in the following, non-limiting examples.

### Example 1—Flight Attendant Training

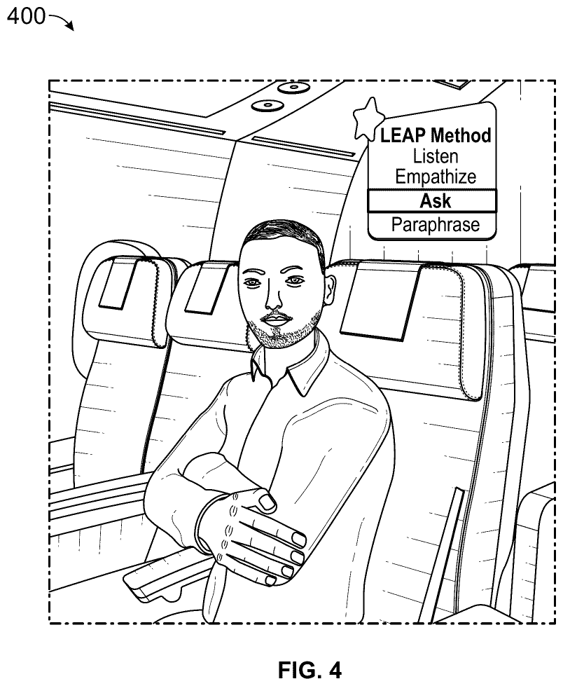

FIG. 4 depicts an embodiment of the present disclosure wherein a user 160 through the use of a virtual reality user interface 105 can interact with a passenger on an airplane. This example embodies one potential training use for the disclosed system and method to train airline flight attendants. As passengers on airplanes have become increasingly difficult to manage and unpredictable, it can be intimidating for new flight attendants to gain the necessary skills to interact with challenging, disruptive, or rude passengers. FIG. 4 shows a potential interface through which a new or training flight attendant could practice interacting with such a passenger. In the context of a virtual reality training user interface, the user can speak naturally in response to prompts from the unruly passenger, observe how the passenger responds, pause and rewind to try a different approach if necessary, track their progress, and access additional training materials or strategies, as shown in FIG. 3, to further enhance their soft skill abilities. The disclosed system and method 100 can adapt to a user's responses, providing a more personalized and effective training experience.

The integration of real-time feedback, personalized coaching, dynamic simulation generation, and allowing a user to speak naturally in response to prompts or industry specific situations or scenarios creates a more effective and engaging learning environment for users 160 and allows for faster and more meaningful soft skill development than existing traditional training modules.

Although FIG. 4 depicts a training scenario for a flight attendant in training, this training methodology and interface could be used to train individuals in any industry where soft skill development is important. For example, the disclosed training model could be used in sales to assist new sales representatives to meet sale objectives, responding to uninterested buyers, and other sales techniques.

Other non-limiting industries in which the disclosed system and method could be used include medicine, law, education, consumer service, law enforcement, business development, as well as in non-commercial situations, such as in interpersonal relationships, family dynamics, and personal growth.

While particular embodiments of the present invention have been shown and described, it should be noted that changes and modifications may be made without departing from the presently disclosed inventive concepts in its broader aspects and, therefore, the aim in the appended claims is to cover all such changes and modifications as fall within the true spirit and scope of this invention.

What is claimed is:

1. A system for interactive soft skills training, comprising:
a server configured to process user interactions and manage data storage via a user interface configured for interaction via web, virtual reality, and mobile platforms;
a database storing user data, training scenarios, and feedback logs generated from user interactions via the user interface;
artificial intelligence algorithms configured to process information stored in the database and generate user interactions and provide real-time feedback; and
a chatbot and virtual avatar trained using machine learning to interact audio-visually with the user.

2. The system of claim 1 further comprising a rewind and retry module configured to snapshot conversation states between the user and the chatbot and enabling branch-and-replay while preserving the history of the user interactions with the chatbot.

3. The system of claim 1 further comprising a behavioral analysis engine configured to read the user's face, voice, and text through facial vectors, speech prosody, and textual context.

4. The system of claim 1 further comprising a behavioral analysis engine configured to read the virtual avatar's face, voice, and text through facial vectors, speech prosody, and textual context.

5. The system of claim 1 further comprising an augmented feedback overlay providing feedback overlaid on the user interface during a user interaction.

6. The system of claim 1 further comprising a timeline analysis interface to track conversation turns, emotion curves, and milestone flags during a user interaction via click to zoom navigation.

7. The system of claim 1 further comprising an instant coaching module providing real-time feedback and suggestions for improvement of the user's soft skills based on a user interaction.

8. The system of claim 1 further comprising a meta prompt module, wherein the user provides inputs to prompt the system to generate a customized user interaction.

9. The system of claim 1 further comprising a voice-driven user interaction building module, wherein the user provides audio inputs to prompt the system to generate a customized user interaction.

10. The system of claim 1 further comprising a fast mode user interaction building module, wherein the user provides basic details regarding a desired user interaction the user wishes to generate and the system leverages the basic details and machine learning to generate the desired user interaction.

11. The system of claim 1 further comprising a multi-provider large language model (LLM) router, wherein the multi-provider LLM router alternates between LLM's to improve AI uptime and cost stability of the system.

12. The system of claim 1 further comprising a dynamic milestone module, wherein the user inputs desired elements of the user interaction and the system uses such desired elements to assess the user's performance.

13. The system of claim 1 further comprising an avatar creation module, wherein user inputs generate a visual depiction of the chatbot.

14. The system of claim 1 further comprising a multi-participant real-time conversation module, wherein a plurality of AI agents and users share media content and collaboratively interact in real time.

15. The system of claim 1 further comprising an AI dialing and conversation engine, wherein the AI conversation and dialing engine is configured to leverage machine learning and user inputs to make sales calls.

16. The system of claim 1 further comprising an AI video-podcast maker module, wherein the AI video-podcast maker module is configured to leverage machine learning and user inputs to turn text into multi-host video podcasts with synchronized slides.

17. The system of claim 1 further comprising a multi-dimensional skill tracker module configured to track and analyze emotions of the user and chatbot throughout the course of a user interaction.

18. The system of claim 1 further comprising a chatbot personality finer-tuner module configured to enable the user to manipulate the personality of the chatbot in a user interaction using psychometric sliders and text prompts.

19. A method for interactive soft skills training, utilizing a server configured to process user interactions and manage data storage via a user interface configured for interaction via web, virtual reality, and mobile platforms, the method comprising:
providing a database storing user data, training scenarios, and feedback logs generated from user interactions via the user interface;
processing first information stored in the database to generate a new user interaction;
processing second information obtained from the user interface based on the new user interaction in order to provide real-time feedback via the user interface; and
providing a chatbot and virtual avatar trained using machine learning to interact audio-visually with the user;
wherein the user interface is configured to engage with the chatbot.

20. The method of claim 19 further comprising providing a rewind and retry module configured to snapshot conversation states between the user and the chatbot and enabling branch-and-replay while preserving the history of the user interactions with the chatbot.
